(19) United States
(12) Patent Application Publication
(10) Pub. No.: US 2026/0163776 A1
(43) Pub. Date: Jun. 11, 2026

(54) MIXED NUMEROLOGY SLOT STRUCTURE FOR SIDELINK COMMUNICATION

(71) Applicant: QUALCOMM Incorporated, San Diego, CA (US)

(72) Inventors: Itay IFERGAN, Tel Aviv - Jaffa (IL); Moshe BEN-ARI, Rehovot (IL); Michael LEVITSKY, Rehovot (IL); Alexander SVERDLOV, Rehovot (IL)

(21) Appl. No.: 18/972,656

(22) Filed: Dec. 6, 2024

(51) Int. Cl. H04L 27/26; H04W 52/52; H04W 72/0446

(52) U.S. Cl. CPC H04L 27/26025; H04W 52/52; H04W 72/0446

(57) ABSTRACT

Methods, systems, and devices for wireless communication are described. Various aspects relate to mixed numerology slot structures for sidelink communication. Some aspects more specifically relate to mixed numerology slot structures that define how a slot may be associated with two or more subcarrier spacings (SCSs). For example, a mixed numerology slot structure may define that a first set of one or more symbols of a slot is associated with a first SCS and that a second set of one or more symbols of the slot is associated with a second SCS. Symbols of the slot that are associated with a communication direction switch or automatic gain control (AGC) training may be associated with a relatively largest SCS. Other symbols of the slot may be associated with any combination of one or more other SCSs in accordance with the mixed numerology slot structure.

### FIELD OF TECHNOLOGY

The following relates to wireless communication, including mixed numerology slot structure for sidelink communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, multiple UEs may communicate directly with each other via a sidelink. Sidelink communication may be associated with a specific slot structure, which may depend on whether one or more UEs intend to use the slot for communicating data or for communicating both data and feedback. For example, UEs may use a first slot structure for data communication and may use a second slot structure for data and feedback communication. Each of the two slot structures may include 14 symbols and may be associated with a uniform numerology. In accordance with the two slot structures being associated with a uniform numerology, a UE may transmit or receive communication using a single subcarrier spacing (SCS) throughout a slot.

### SUMMARY

The systems, methods, and devices of this disclosure each have several innovative aspects, no single one of which is solely responsible for the desirable attributes disclosed herein.

A method for wireless communication by a user equipment (UE) is described. The method may include communicating (e.g., transmitting or receiving), within a first set of one or more symbols of a slot associated with a mixed numerology sidelink slot structure, first sidelink signaling in accordance with a first subcarrier spacing (SCS) and communicating (e.g., transmitting or receiving), within a second set of one or more symbols of the slot associated with the mixed numerology sidelink slot structure, second sidelink signaling in accordance with a second SCS different from the first SCS.

A UE for wireless communication is described. The UE may include one or more memories storing processor executable code, and one or more processors coupled with the one or more memories. The one or more processors may individually or collectively be operable to execute the code to cause the UE to communicate (e.g., transmit or receive), within a first set of one or more symbols of a slot associated with a mixed numerology sidelink slot structure, first sidelink signaling in accordance with a first SCS and communicate (e.g., transmit or receive), within a second set of one or more symbols of the slot associated with the mixed numerology sidelink slot structure, second sidelink signaling in accordance with a second SCS different from the first SCS.

Another UE for wireless communication is described. The UE may include means for communicating (e.g., transmitting or receiving), within a first set of one or more symbols of a slot associated with a mixed numerology sidelink slot structure, first sidelink signaling in accordance with a first SCS and means for communicating (e.g., transmitting or receiving), within a second set of one or more symbols of the slot associated with the mixed numerology sidelink slot structure, second sidelink signaling in accordance with a second SCS different from the first SCS.

A non-transitory computer-readable medium storing code for wireless communication is described. The code may include instructions executable by one or more processors to communicate (e.g., transmit or receive), within a first set of one or more symbols of a slot associated with a mixed numerology sidelink slot structure, first sidelink signaling in accordance with a first SCS and communicate (e.g., transmit or receive), within a second set of one or more symbols of the slot associated with the mixed numerology sidelink slot structure, second sidelink signaling in accordance with a second SCS different from the first SCS.

In some examples of the method, UEs, and non-transitory computer-readable medium described herein, the mixed numerology sidelink slot structure may be associated with two or more SCSs including the first SCS and the second SCS and the mixed numerology sidelink slot structure defines that one or more first symbols of the slot associated with automatic gain control (AGC) and one or more second symbols of the slot associated with a communication direction switch may have a duration associated with a largest SCS of the two or more SCSs.

Some examples of the method, UEs, and non-transitory computer-readable medium described herein may further include operations, features, means, or instructions for remaining symbols of the slot outside of the one or more first symbols associated with the AGC and the one or more second symbols associated with the communication direction switch may be associated with any combination of one or more of the two or more SCSs.

In some examples of the method, UEs, and non-transitory computer-readable medium described herein, the one or more first symbols associated with the AGC and the remaining symbols may have a same power spectrum density.

In some examples of the method, UEs, and non-transitory computer-readable medium described herein, the UE generates a first symbol of the slot associated with AGC in accordance with a subsequent symbol of the slot that may be adjacent to the first symbol.

In some examples of the method, UEs, and non-transitory computer-readable medium described herein, the first symbol may be a duplication of the subsequent symbol in accordance with the first symbol and the subsequent symbol being associated with a same SCS.

In some examples of the method, UEs, and non-transitory computer-readable medium described herein, the subsequent symbol includes a set of populated subcarriers and the first symbol includes a uniformly distributed subset of populated subcarriers from the set of populated subcarriers.

In some examples of the method, UEs, and non-transitory computer-readable medium described herein, the uniformly distributed subset of populated subcarriers within the first symbol may be selected from the set of populated subcarriers within the subsequent symbol at a rate associated with a difference in SCS between the first symbol and the subsequent symbol.

In some examples of the method, UEs, and non-transitory computer-readable medium described herein, each symbol of the first set of one or more symbols includes a first cyclic prefix (CP) duration at a beginning of that symbol, the first CP duration associated with a first symbol size that corresponds to the first SCS and a fixed CP to symbol size ratio and each symbol of the second set of one or more symbols includes a second CP duration at a beginning of that symbol, the second CP duration associated with a second symbol size that corresponds to the second SCS and the fixed CP to symbol size ratio.

In some examples of the method, UEs, and non-transitory computer-readable medium described herein, the first set of one or more symbols includes two symbols, an initial symbol of the two symbols excluding a CP and a second symbol of the two symbols including a CP duration at a beginning of the second symbol, the CP duration associated with a symbol size that corresponds to the second SCS and each symbol of the second set of one or more symbols includes the CP duration at a beginning of that symbol.

In some examples of the method, UEs, and non-transitory computer-readable medium described herein, the initial symbol of the two symbols may be an AGC training symbol.

In some examples of the method, UEs, and non-transitory computer-readable medium described herein, the first set of one or more symbols includes two symbols, an initial symbol of the two symbols including a CP duration at a beginning of the initial symbol and a second symbol of the two symbols excluding a CP, the CP duration associated with a symbol size that corresponds to the second SCS and each symbol of the second set of one or more symbols includes the CP duration at a beginning of that symbol.

In some examples of the method, UEs, and non-transitory computer-readable medium described herein, the second symbol of the two symbols may be associated with a communication direction switch.

Some examples of the method, UEs, and non-transitory computer-readable medium described herein may further include operations, features, means, or instructions for receiving an indication of the mixed numerology sidelink slot structure, where communication (e.g., transmission or reception) in accordance with the mixed numerology sidelink slot structure may be in association with reception of the indication of the mixed numerology sidelink slot structure.

Some examples of the method, UEs, and non-transitory computer-readable medium described herein may further include operations, features, means, or instructions for transmitting information indicative of a capability of the UE associated with one or more mixed numerology sidelink slot structures, where reception of the indication of the mixed numerology sidelink slot structure may be in association with transmission of the information indicative of the capability of the UE.

In some examples of the method, UEs, and non-transitory computer-readable medium described herein, the UE receives the indication of the mixed numerology sidelink slot structure as an instruction to switch to the mixed numerology sidelink slot structure from another mixed numerology sidelink slot structure.

In some examples of the method, UEs, and non-transitory computer-readable medium described herein, the UE receives the indication of the mixed numerology sidelink slot structure as an instruction to switch to the mixed numerology sidelink slot structure from a uniform numerology sidelink slot structure.

Some examples of the method, UEs, and non-transitory computer-readable medium described herein may further include operations, features, means, or instructions for receiving an indication of a uniform numerology sidelink slot structure, where the UE receives the indication of the uniform numerology sidelink slot structure as an instruction to switch to the uniform numerology sidelink slot structure from the mixed numerology sidelink slot structure, and communicating (e.g., transmitting or receiving), within symbols of a second slot associated with the uniform numerology sidelink slot structure, third sidelink signaling in accordance with a uniform SCS.

In some examples of the method, UEs, and non-transitory computer-readable medium described herein, the UE selects or receives an indication of the mixed numerology sidelink slot structure in accordance with a satisfaction of one or more conditions.

Details of one or more aspects of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports mixed numerology slot structure for sidelink communication in accordance with one or more aspects of the present disclosure.

FIG. 2 shows examples of uniform numerology slot structures for sidelink communication in accordance with one or more aspects of the present disclosure.

FIG. 3 shows an example of a signaling diagram that supports a mixed numerology slot structure for sidelink communication in accordance with one or more aspects of the present disclosure.

FIGS. 4-10 show examples of mixed numerology slot structures for sidelink communication in accordance with one or more aspects of the present disclosure.

FIG. 11 shows examples of cyclic prefix (CP) placements that support a mixed numerology slot structure for sidelink communication in accordance with one or more aspects of the present disclosure.

FIG. 12 shows an example of a process flow that supports a mixed numerology slot structure for sidelink communication in accordance with one or more aspects of the present disclosure.

FIGS. 13 and 14 show block diagrams of devices that support mixed numerology slot structure for sidelink communication in accordance with one or more aspects of the present disclosure.

FIG. 15 shows a block diagram of a communications manager that supports mixed numerology slot structure for sidelink communication in accordance with one or more aspects of the present disclosure.

FIG. 16 shows a diagram of a system including a device that supports mixed numerology slot structure for sidelink communication in accordance with one or more aspects of the present disclosure.

FIGS. 17 through 19 show flowcharts illustrating methods that support mixed numerology slot structure for sidelink communication in accordance with one or more aspects of the present disclosure.

### DETAILED DESCRIPTION

In some wireless communications systems, a user equipment (UE) may support sidelink communication according to which the UE may communicate directly with another UE. Sidelink communication may be associated with a specific slot structure, which may depend on whether the UE intends to use the slot for communicating data or for communicating both data and feedback. For example, a first slot structure may be associated with just data communication and a second slot structure may be associated with both data and feedback communication. Each of the two slot structures may include 14 symbols and may be associated with a uniform (e.g., same or consistent) numerology. In accordance with the two slot structures being associated with a uniform numerology, a UE may transmit or receive communication using a single subcarrier spacing (SCS) throughout a slot and each symbol of the slot may have a same duration.

Further, each of the two slot structures may include at least one empty symbol (e.g., a symbol absent of sidelink signaling) and at least one duplicated symbol (e.g., a symbol that is a duplicate of another symbol). A UE may use an empty symbol to perform a communication direction switch and may use a duplicated symbol to perform automatic gain control (AGC) training. Such symbols may provide time to perform a communication direction switch or AGC training at the cost of introducing redundancy or overhead within sidelink slots. In some systems, such symbols may have larger durations than a UE actually uses to perform a communication direction switch or AGC training, which may result in lower slot efficiency and lower throughput without a corresponding gain in UE performance. For example, some UEs may be capable of performing a communication direction switch or AGC training in less time than is provided by symbols dedicated for those purposes, which may result in some amount of unused time within each slot. Thus, some systems may benefit from additional configurational- or signaling-based mechanisms according to which a UE may communicate (e.g., transmit or receive) in accordance with a slot structure associated with varying symbol durations such that symbols associated with a communication direction switch or AGC training are relatively shorter than other symbols within the slot.

Various aspects relate generally to mixed numerology slot structures for sidelink communication. Some aspects more specifically relate to mixed numerology slot structures that define how a slot may be associated with two or more numerologies (e.g., two or more SCSs and two or more corresponding symbol durations). For example, a mixed numerology sidelink slot structure may define that a first set of one or more symbols of a slot is associated with a first numerology (e.g., a first SCS and a first symbol duration corresponding to the first SCS) and that a second set of one or more symbols of the slot is associated with a second numerology (e.g., a second SCS different from the first SCS and a second symbol duration corresponding to the second SCS). In some aspects, symbols of the slot that are associated with a communication direction switch or AGC training may be associated with a relatively largest SCS (and, correspondingly, a relatively shortest symbol duration) as compared to other symbols within the slot. The other symbols of the slot (outside of the symbols associated with a communication direction switch or AGC training) may be associated with any combination of one or more other SCSs in accordance with the mixed numerology slot structure. Additional aspects more specifically relate to generation of an AGC training symbol in accordance with a ratio of a first SCS of the AGC training symbol and a second SCS of a subsequent, adjacent symbol of the slot, cyclic prefix (CP) placements in accordance with a mixed numerology slot structure, and signaling mechanisms according to which a UE may use a mixed numerology slot structure, among other aspects described herein.

Particular aspects of the subject matter described herein may be implemented to realize one or more of the following advantages. In some examples, by supporting a mixed numerology slot structure according to which one or more symbols of a slot may have a different duration than one or more other symbols of the slot, a UE may achieve greater throughput by leveraging the mixed numerology slot structure to use relatively shorter symbols for a communication direction switch or AGC training and to use relatively longer symbols for data or feedback communication. By using relatively shorter symbols for a communication direction switch or AGC training and using relatively longer symbols for data or feedback communication, the UE may use a relatively larger percentage of the slot for data or feedback communication (as compared to slot structures associated with a uniform numerology) while still having sufficient time for a communication direction switch or AGC training. Such aspects may reduce the redundancies or overhead present within slot structures associated with a uniform numerology. Likewise, such aspects may support greater throughput and greater slot efficiency while at least maintaining communication reliability resulting from sufficient time for a communication direction switch or AGC training. Thus, various aspects may be implemented to increase sidelink performance (by increasing the throughput in each slot as larger payloads may be transmitted in each slot), which may facilitate or achieve greater spectral efficiency, higher system capacity, lower latency, and improved user experiences.

Aspects of the disclosure are initially described in the context of wireless communications systems. Additionally, aspects of the disclosure are illustrated by and described with reference to example sidelink slot structures, a signaling diagram, example CP placements, and a process flow. Aspects of the disclosure are further illustrated by and described with reference to apparatus diagrams, system diagrams, and flowcharts that relate to mixed numerology slot structure for sidelink communication.

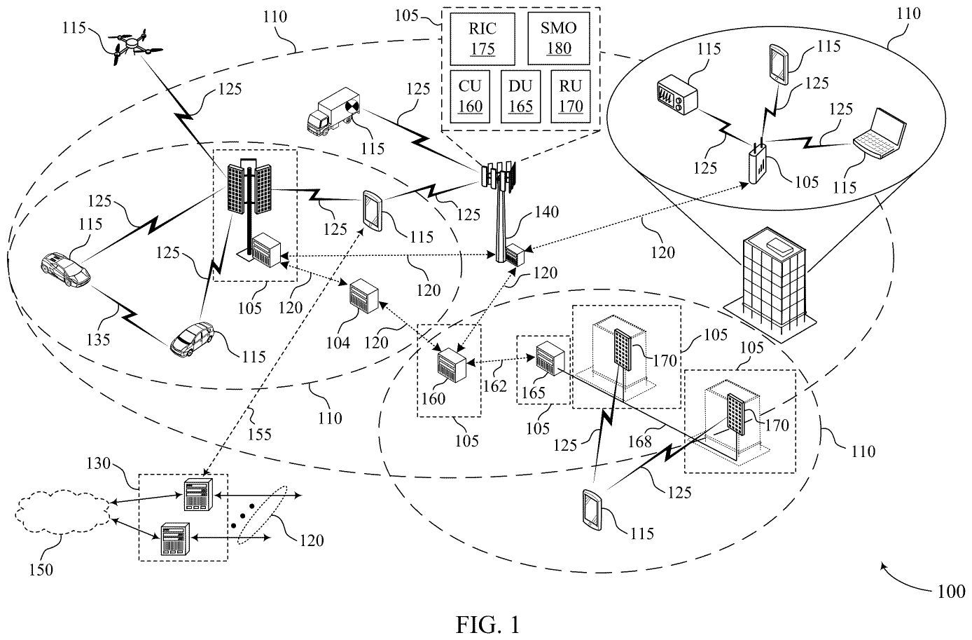

FIG. 1 shows an example of a wireless communications system 100 that supports mixed numerology slot structure for sidelink communication in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support mixed numerology slot structure for sidelink communication as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a CP. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may support sidelink communication according to which the UE 115 may communicate directly with another UE 115 via one or more slots. A sidelink slot (e.g., a slot associated with or otherwise used for sidelink communication) may include one or more of a physical sidelink control channel (PSCCH) stage 1, PSCCH stage 1 pilots, a PSCCH stage 2, a physical sidelink shared channel (PSSCH), one or more PSSCH pilots, one or more channel state information (CSI) reference signals (CSI-RSs), or a physical sidelink feedback channel (PSFCH).

Sidelink communication may be associated with a specific slot structure, which may depend on whether the UE 115 intends to use the slot for communicating data or for communicating both data and feedback. For example, a first slot structure may be associated with (exclusively) data communication and a second slot structure may be associated with data and feedback communication. Each of the two slot structures may include 14 symbols and may be associated with a uniform (e.g., same or consistent) numerology. In accordance with the two slot structures being associated with a uniform numerology, a UE 115 may transmit or receive communication using a single SCS throughout a slot and each symbol of the slot may have a same duration.

In some aspects, a numerology may define a signal's physical waveform in terms of SCS, symbol duration, and slot/frame structure. In some systems, a numerology for sidelink communication (e.g., including V2X communication) may be selected a priory and may be fixed for all symbols/slots per receive pool configuration. Further, in some systems, the slot/subframe structure may be constructed such that there is a redundancy of at least one symbol of the slot/subframe. For example, sidelink slot structures may include at least one empty symbol (e.g., a symbol absent of sidelink signaling) and at least one duplicated symbol (e.g., a symbol that is a duplicate of another symbol). A UE may use an empty symbol for performing a communication direction switch (e.g., a switch or transition between reception and transmission) and may use a duplicated symbol for AGC training. For example, a last (e.g., final) symbol in a slot may be empty (for a communication direction switch). By way of further example, the first and second symbols (e.g., an initial symbol and a symbol immediately subsequent to the initial symbol) may be a duplication of one another (with the initial symbol used for receive-side AGC training). Sidelink slot structures associated with both data and feedback may further include a duplication of a feedback signal over two consecutive symbols (with an earlier of the two consecutive symbols used for receive-side AGC training). Additionally, sidelink slot structures associated with both data and feedback may further include an extra empty symbol prior to the (two consecutive) feedback symbols (for a communication direction switch).

Such redundancies may negatively impact slot efficiency and lower an overall throughput. Further, in some systems, the redundant or empty symbols may have larger durations than a UE 115 actually uses for performing a communication direction switch or AGC training, which may result in lower slot efficiency and lower throughput without a corresponding gain in performance. For example, some UEs 115 may be capable of performing a communication direction switch or AGC training in less time than is provided by symbols dedicated for those purposes, which may result in some amount of unused time within each slot. Thus, some systems may benefit from additional configurational- or signaling-based mechanisms according to which a UE 115 may communicate (e.g., transmit or receive) in accordance with a slot structure associated with varying symbol durations such that symbols associated with a communication direction switch or AGC training are relatively shorter than other symbols within the slot.

In some aspects, two or more UEs 115 may support a mixed numerology sidelink slot structure that defines how a same slot is associated with two or more numerologies (and, likewise, two or more SCSs and two or more corresponding symbol durations). For example, the mixed numerology sidelink slot structure may define that a first set of one or more symbols of a slot are associated with a first numerology (e.g., a first SCS and a first symbol duration corresponding to the first SCS) and that a second set of one or more symbols of the slot are associated with a second numerology (e.g., a second SCS different from the first SCS and a second symbol duration corresponding to the second SCS). In some aspects, symbols of the slot that are associated with a communication direction switch or AGC training may be associated with a relatively largest SCS (and, correspondingly, a relatively shortest symbol duration) as compared to other symbols within the slot. Other symbols of the slot (outside of the symbols associated with a communication direction switch or AGC training) may be associated with any combination of one or more other SCSs in accordance with the mixed numerology sidelink slot structure.

In such aspects, the redundancies within a sidelink slot may be reduced and the mixed numerology sidelink slot structure may allow for more resources (e.g., more time domain resources) to be used for data transmission, which may lead to an increase of throughput. In some aspects, sidelink slots may be especially suitable for such mixed numerology usage, as each sidelink slot has the redundancies of AGC symbol duplication and communication direction switching (e.g., transmission-to-reception transition, or vice versa). Accordingly, various aspects of the present disclosure relate to configurational- or signaling-based mechanisms or definitions of mixed numerology slot structures for sidelink transmissions, which may reduce information redundancy and increase throughput without incurring performance degradation (e.g., while maintaining sidelink AGC performance and reliable communication direction switches within an allotted time period).

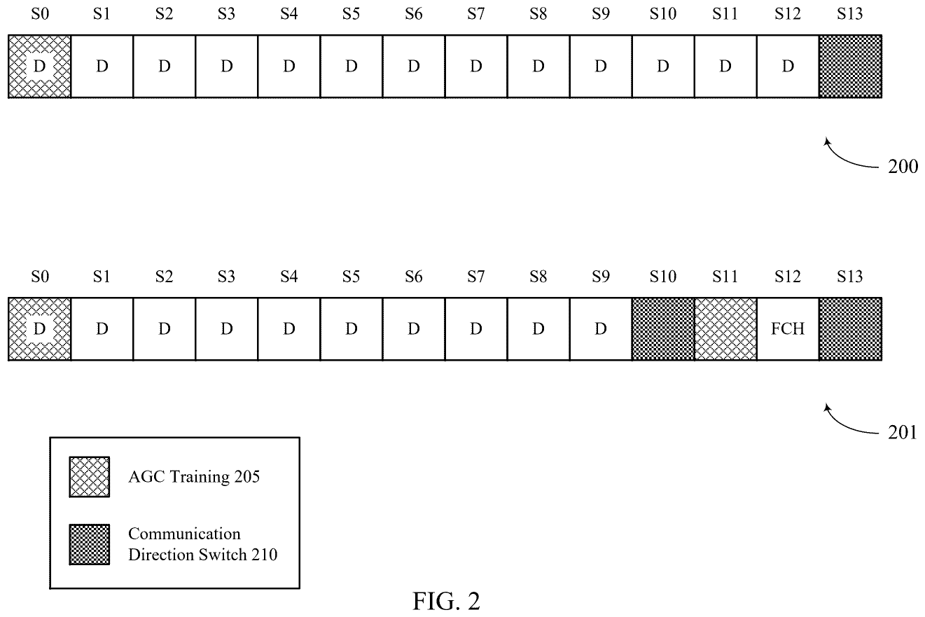

FIG. 2 shows examples of uniform numerology slot structures 200 and 201 for sidelink communication in accordance with one or more aspects of the present disclosure. The uniform numerology slot structure 200 may be associated with (e.g., define) a slot in which data is communicated between two or more UEs 115 and the uniform numerology slot structure 201 may be associated with (e.g., define) a slot in which both data and feedback are communicated between two or more UEs 115. Symbols via which data is communicated may be represented by a “D” and symbols via which feedback is communicated may be represented by an “FCH,” which may stand for feedback channel. Symbols may generally be represented by “S,” such that an initial symbol of a slot may be represented as S0, a second symbol of the slot may be represented as S1, and so on. UEs 115 may communicate data via one or both of a PSCCH or a PSSCH. UEs 115 may communicate feedback via a PSFCH. The uniform numerology slot structure 200 may define a non-PSFCH slot and the uniform numerology slot structure 201 may define a PFSCH slot.

Each of the uniform numerology slot structure 200 and the uniform numerology slot structure 201 may be associated with 14 symbols defined by S0-S13. Further each of the uniform numerology slot structure 200 and the uniform numerology slot structure 201 may be associated with one or more symbols associated with AGC training 205 and one or more symbols associated with a communication direction switch 210. In accordance with the uniform numerology slot structure 200, S0 may be associated with AGC training 205 and S13 may be associated with a communication direction switch 210. In accordance with the uniform numerology slot structure 201, S0 may be associated with AGC training 205, S10 may be associated with a communication direction switch 210, S11 may be associated with AGC training 205, and S13 may be associated with a communication direction switch 210.

The uniform numerology slot structure 200 and the uniform numerology slot structure 201 may be associated with a same or consistent numerology/SCS throughout, such that each symbol of a slot defined by the uniform numerology slot structure 200 or the uniform numerology slot structure 201 is associated with a same SCS and has a same symbol duration. In some systems, a numerology or structure of S0 and S13 of the uniform numerology slot structure 200 may be modified for higher throughputs and a numerology or structure of S0, S10, S11, and S13 of the uniform numerology slot structure 201 may be modified for higher throughputs.

In some aspects, one or more UEs 115 may select, identify, ascertain, or otherwise determine to communicate in accordance with the uniform numerology slot structure 200 or the uniform numerology slot structure 201 in accordance with a satisfaction of one or more first conditions, a first resource pool configuration, signaling indicative of an instruction to use the uniform numerology slot structure 200 or the uniform numerology slot structure 201, or any combination thereof. Additionally, in some aspects, one or more UEs 115 may select, identify, ascertain, or otherwise determine switch from communicating in accordance with the uniform numerology slot structure 200 or the uniform numerology slot structure 201 to communicating in accordance with a mixed numerology slot structure. The one or more UEs 115 may select, identify, ascertain, or otherwise determine to communicate in accordance with the mixed numerology slot structure in accordance with a satisfaction of one or more second conditions, a second resource pool configuration, signaling indicative of an instruction to use the mixed numerology slot structure, or any combination thereof. Generally, one or more UEs 115 may dynamically, semi-statically, semi-persistently, or periodically switch between using a uniform numerology slot structure and using a mixed numerology slot structure in accordance with a satisfaction of one or more conditions, a resource pool configuration, signaling indicative of an instruction to use the mixed numerology slot structure, or any combination thereof.

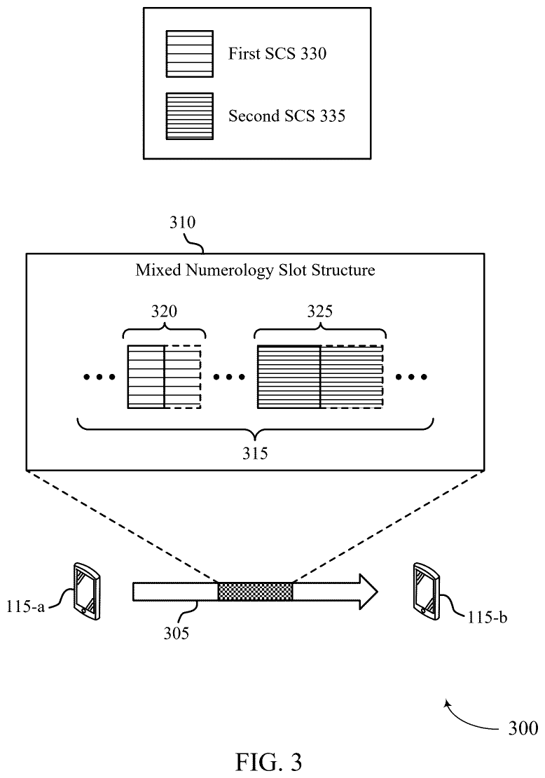

FIG. 3 shows an example of a signaling diagram 300 that supports mixed numerology slot structure for sidelink communication in accordance with one or more aspects of the present disclosure. The signaling diagram 300 may implement or be implemented to realize one or more aspects described herein. For example, the signaling diagram 300 illustrates communication between a UE 115-a and a UE 115-b, which may be examples of corresponding devices illustrated or described herein, including by or with reference to FIGS. 1 and 2. In some aspects, the signaling diagram 300 illustrates communication of sidelink signaling between the UE 115-a and the UE 115-b via a sidelink 305 in accordance with a mixed numerology slot structure 310 (e.g., which may be understood or referred to as a mixed numerology sidelink slot structure).

In some aspects, using mixed numerologies may entail the use of different SCS values in a same slot. For example, in accordance with the mixed numerology slot structure 310, the UE 115-a and the UE 115-b may use at least a first SCS 330 and a second SCS 335 within a slot 315. In such examples, the UE 115-a may transmit first sidelink signaling via a first set of one or more symbols 320 of the slot 315 using the first SCS 330 and may transmit second sidelink signaling via a second set of one or more symbols 325 of the slot 315 using the second SCS 335. The first SCS 330 may be a multiple of the second SCS 335. For example, the second SCS 335 may be an original or baseline SCS and the first SCS 330 may be two or four (among other examples) times the original or baseline SCS. In other words, the first SCS 330 may be equal to two or four times the second SCS 335, among other examples.

In some aspects, increasing the SCS may lead to shorter symbol durations, allowing for more parts of the slot 315 to be used for data transmission. SCS size may also inversely affect a quantity of subcarriers in a symbol. For example, a symbol with two times (e.g., ×2) SCS size may have one-half (e.g., ×0.5) the subcarriers as compared to a baseline (e.g., ×1) SCS size. Further, the UE 115-a or the UE 115-b may support different slot and symbol structures in association with supporting the mixed numerology slot structure 310, along with corresponding channel estimation techniques. For example, the UE 115-b (a receiver of the slot 315) may perform channel estimation for shorter symbol durations by applying one or both of time domain interpolation or frequency domain interpolation. In such examples, the UE 115-a may refrain from including pilots within such short symbols.

The mixed numerology slot structure 310 may be associated with any combination or permutation of two or more SCSs including at least the first SCS 330 and the second SCS 335. Thus, the mixed numerology slot structure 310 may be associated with two different SCSs, three different SCSs, four different SCSs, or any other quantity of different SCSs. Further, the first sidelink signaling and the second sidelink signaling may refer generally to sidelink signaling transmitted within one or more symbols of a slot. The first sidelink signaling and the second sidelink signaling may be the same signaling or different signaling. For example, sidelink signaling may refer to one or more of sidelink control information (SCI), sidelink data, sidelink feedback, a power reference signal, or any combination thereof. In some aspects, for example, the first sidelink signaling may refer to sidelink signaling transmitted by the UE 115-a within one or more symbols associated with AGC training and the second sidelink signaling may refer to sidelink signaling transmitted by the UE 115-a within one or more symbols associated with data or feedback communication, among other examples.

In accordance with the mixed numerology slot structure 310, a complete set of symbols within the slot 315 (except for symbols associated with a communication direction switch) may have a same power spectrum density. For example, the UE 115-a may normalize a power in at least a subset of symbols such that the power of the complete set of symbols within the slot 315 (except for symbols associated with a communication direction switch) is equal or uniform. By way of example, the UE 115-a may transmit symbols associated with a relatively greater SCS with a greater per-subcarrier or per-resource element (RE) transmission power and may transmit symbols associated with a relatively smaller SCS with a lower per-subcarrier or per-RE transmission power.

In some aspects, the mixed numerology slot structure 310 may define that, of the two or more SCSs associated with the mixed numerology slot structure 310, the UE 115-a may use one or more largest or approximately largest SCSs for one or more symbols associated with AGC training or a communication direction switch. In such aspects, the one or more symbols associated with AGC training or a communication direction switch may be associated with a shortest duration relative to other symbols within the slot 315. One or more first symbols associated with AGC training and one or more second symbols associated with a communication direction switch may be associated with a same SCS or may be associated with two different SCSs. The same SCS may be a relatively largest SCS of the two or more SCSs associated with the mixed numerology slot structure 310. The two different SCSs may be relatively largest SCSs (e.g., a largest and a next largest) of the two or more SCSs associated with the mixed numerology slot structure 310.

In some aspects, the UE 115-a may generate a first symbol associated with AGC training in accordance with a second (subsequent, adjacent) symbol and in accordance with a difference in SCS between the first symbol and the second symbol. For example, the UE 115-a may generate the first symbol as a duplication of the second symbol in accordance with the first symbol and the second symbol being associated with a same SCS. By way of further example, the UE 115-a may generate the first symbol as including a subset of populated subcarriers of a set of populated subcarriers of the second symbol in accordance with the first symbol being associated with a greater SCS than the second symbol.

In such examples, for instance, the first symbol may use uniformly distributed subcarriers (e.g., REs) from the second (following adjacent) symbol with a rate that is associated with a difference in SCS between the first symbol and the second symbol. Such a rate may be denoted or calculated as agc_SCS/adjacent_SCS (e.g., a quotient of or a ratio between the two SCSs). The subset of populated subcarriers within the first symbol may be defined from a starting point of the set of populated subcarriers within the second symbol. For example, if agc_SCS/adjacent_SCS=2, the UE 115-a may select even or odd subcarriers or REs from the set of populated subcarriers or REs within the second symbol, where the initial subcarrier or RE index may be 0 or 1. If agc_SCS/adjacent_SCS=4, the UE 115-a may select 1:4 subcarriers or REs from the set of populated subcarriers or REs within the second symbol, where the initial subcarrier or RE index may be 0, 1, 2, or 3.

The mixed numerology slot structure 310, or any other slot structure that the UE 115-a and the UE 115-b may use for sidelink communication, may be fixed and constant (e.g., in accordance with a network specification). Additionally, or alternatively, the mixed numerology slot structure 310, or any other slot structure that the UE 115-a and the UE 115-b may use for sidelink communication, may be changed in real time, using signaling between the UE 115-a and the UE 115-b or signaling from a network entity 105, or any combination thereof. The UE 115-a or the UE 115-b, or both, may receive an indication of the mixed numerology slot structure 310 in accordance with a sidelink mode (e.g., sidelink mode 1) and, in some aspects, the network entity 105 may schedule changes in sidelink slot structure in accordance with a logic (e.g., one or more conditions, considerations, or parameters).

In some examples, the UE 115-a and the UE 115-b may support a signaling for toggling between mixed and uniform numerology slot structures, as a switch to mixed numerologies may lead to increased throughput in some scenarios. In some aspects, the signaling for toggling between mixed and uniform numerology slot structures may account for the capabilities of the UEs 115 (e.g., all UEs 115) within a network. Additionally, or alternatively, the UE 115-a and the UE 115-b may support a signaling for toggling between different slot structures with mixed numerologies (e.g., a first mixed numerology slot structure may lead to an increase in throughput, such as a greater amount of data, over a second mixed numerology slot structure while balancing CP duration for other, such as distant, UEs 115).

In some aspects, the UE 115-a, the UE 115-b, or a network entity 105 (configuring a sidelink slot structure) may increase a size of a PSCCH portion of a sidelink slot in accordance with one or more of the example mixed numerology slot structures described herein. For example, in accordance with some example mixed numerology slot structures described herein, an additional PSCCH configuration of +1 symbol may be added to reduce or manage a code rate associated with the PSCCH portion. Additionally, or alternatively, one or more of the example mixed numerology slot structures described herein may efficiently balance a code rate across a PSCCH portion of a sidelink slot and a PSSCH portion of the sidelink slot.

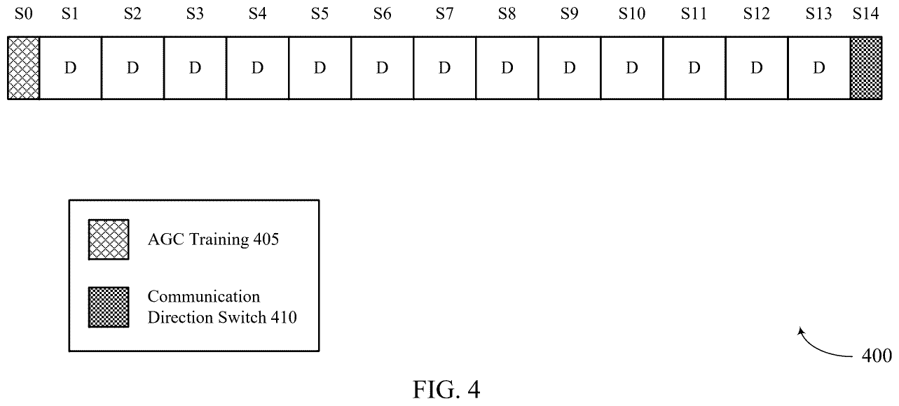

FIG. 4 shows an example of a mixed numerology slot structure 400 for sidelink communication in accordance with one or more aspects of the present disclosure. The mixed numerology slot structure 400 may implement or be implemented to realize one or more aspects of the present disclosure. For example, the mixed numerology slot structure 400 may be an example of the mixed numerology slot structure 310, as illustrated by and described with reference to FIG. 3. The mixed numerology slot structure 400 may define a non-PSFCH slot and may include a symbol (e.g., S0) associated with AGC training 405 and a symbol (e.g., S14) associated with a communication direction switch 410.

In accordance with the mixed numerology slot structure 400, S0 (an initial symbol of a slot associated with the AGC training 405) may use a doubled SCS (e.g., relative to a baseline SCS, such as a smaller SCS associated with the mixed numerology slot structure 400) and may have a duration of one-half a baseline symbol length (such as one-half of a duration of, for example, S1). S14 may be an empty symbol associated with a communication direction switch 410 and may have a same length as S0 (e.g., a same length or duration of a doubled SCS symbol). In other words, S0 may be associated with a first SCS, S1-S13 may be associated with a second SCS, and S14 may have a duration associated with (e.g., defined by) the first SCS. In accordance with such aspects of the mixed numerology slot structure 400, a slot defined in accordance with the mixed numerology slot structure 400 may include 13 unique data symbols associated with a baseline SCS.

In some aspects, a UE 115 (e.g., the UE 115-a) may generate S0 as a duplication of a subset of subcarriers of S1. For example, the UE 115 may generate s0 as a duplication of the even or odd subcarriers of S1. A UE 115 may use S0 (e.g., an AGC symbol) as a power reference signal, such as for AGC computation. In accordance with the generation of S0 as being the even or odd subcarriers of S1, S0 power may represent S1 power. Additionally, or alternatively, a UE 115 may use S0 to carry some amount of duplicated data. For example, a UE 115 may use subcarriers of S0 to carry a subset of a set of data conveyed via S1. In such examples, if a gain state is not changed over S0, a receiving UE 115 may generate log likelihood ratios (LLRs) of S0 and combine the generated LLRs with, for example, one-half of the LLRs of S1.

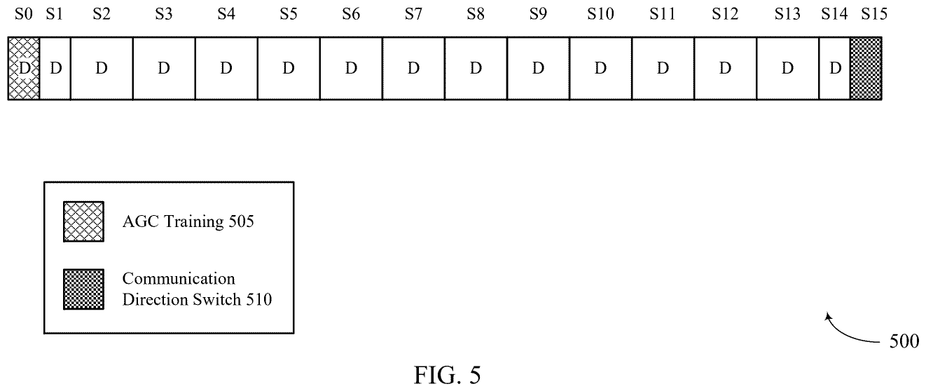

FIG. 5 shows an example of a mixed numerology slot structure 500 for sidelink communication in accordance with one or more aspects of the present disclosure. The mixed numerology slot structure 500 may implement or be implemented to realize one or more aspects of the present disclosure. For example, the mixed numerology slot structure 500 may be an example of the mixed numerology slot structure 310, as illustrated by and described with reference to FIG. 3. The mixed numerology slot structure 500 may define a non-PSFCH slot and may include a symbol (e.g., S0) associated with AGC training 505 and a symbol (e.g., S15) associated with a communication direction switch 510.

In accordance with the mixed numerology slot structure 500, S0, S1, and S14 may use a doubled SCS size (e.g., relative to a baseline SCS, such as a lowest SCS associated with the mixed numerology slot structure 500) with S15 (e.g., a guard symbol) being an empty symbol with a same duration as S0, S1, and S14. In other words, S0, S1, and S14 may be associated with a first SCS, S2-S13 may be associated with a second SCS, and S15 may have a duration associated with (e.g., defined by) the first SCS. In accordance with such aspects of the mixed numerology slot structure 500, a slot defined in accordance with the mixed numerology slot structure 500 may include 14 unique data symbols. In some aspects, S1 and S14 may include or carry one-half (e.g., ×0.5) a quantity of subcarriers compared to S2-S13. In such aspects, each of S1 and S14 may include or carry one-half the amount of data as compared to a symbol in the range of S2-S13.

In some aspects, S0 (e.g., an AGC symbol) may be a duplication of S1, which may facilitate lower complexity for a UE 115 transmitting a slot in accordance with the mixed numerology slot structure 500. A UE 115 receiving the slot may use S0 for message decoding, which my improve performance in scenarios in which the gain state has not changed, in aspects in which S0 is a duplication of S1 (e.g., by LLR combining).

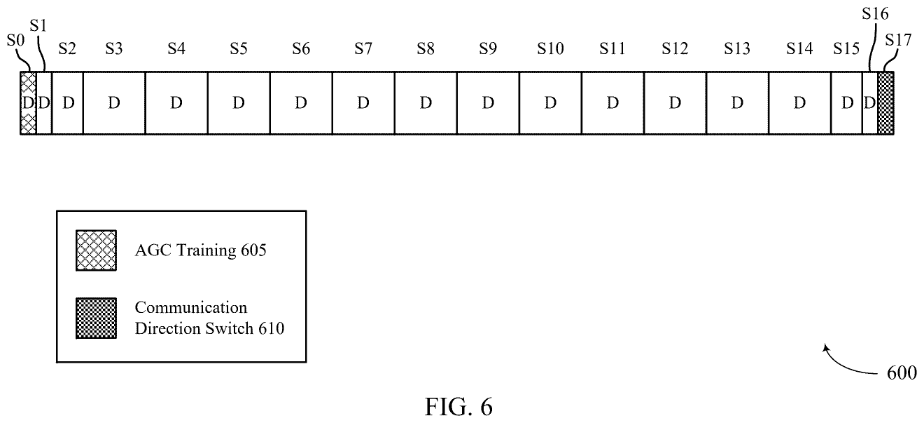

FIG. 6 shows an example of a mixed numerology slot structure 600 for sidelink communication in accordance with one or more aspects of the present disclosure. The mixed numerology slot structure 600 may implement or be implemented to realize one or more aspects of the present disclosure. For example, the mixed numerology slot structure 600 may be an example of the mixed numerology slot structure 310, as illustrated by and described with reference to FIG. 3. The mixed numerology slot structure 600 may define a non-PSFCH slot and may include a symbol (e.g., S0) associated with AGC training 605 and a symbol (e.g., S17) associated with a communication direction switch 610.

In accordance with the mixed numerology slot structure 600, S0, S1, and S16 may use a quadrupled SCS size (e.g., relative to a baseline SCS, such as a lowest SCS associated with the mixed numerology slot structure 600), S2 and S15 may use doubled SCS size (e.g., relative to the baseline SCS), and S17 (e.g., a guard symbol) may be an empty symbol with a same duration as S0, S1, and S16. In other words, S0, S1, and S16 may be associated with a first SCS, S2 and S15 may be associated with a second SCS, S3-S14 may be associated with a third SCS, and S17 may have a duration associated with (e.g., defined by) the first SCS. In accordance with such aspects of the mixed numerology slot structure 600, a slot defined in accordance with the mixed numerology slot structure 600 may include 16 unique data symbols. In some aspects, S1 and S16 may include or carry one-fourth (e.g., ×0.25) a quantity of subcarriers compared to S3-S14. In some aspects, S2 and S15 may include or carry one-half (e.g., ×0.5) a quantity of subcarriers compared to S3-S14. In such aspects, each of S1 and S14 may include or carry one-fourth the amount of data as compared to a symbol in the range of S3-S14 and S2 and S15 may include or carry one-half the amount of data as compared to a symbol in the range of S3-S14.

In some aspects, S0 (e.g., an AGC symbol) may be a duplication of S1, which may facilitate lower complexity for a UE 115 transmitting a slot in accordance with the mixed numerology slot structure 500. A UE 115 receiving the slot may use S0 for message decoding, which my improve performance in scenarios in which an AGC state has not changed, in aspects in which S0 is a duplication of S1 (e.g., by LLR combining).

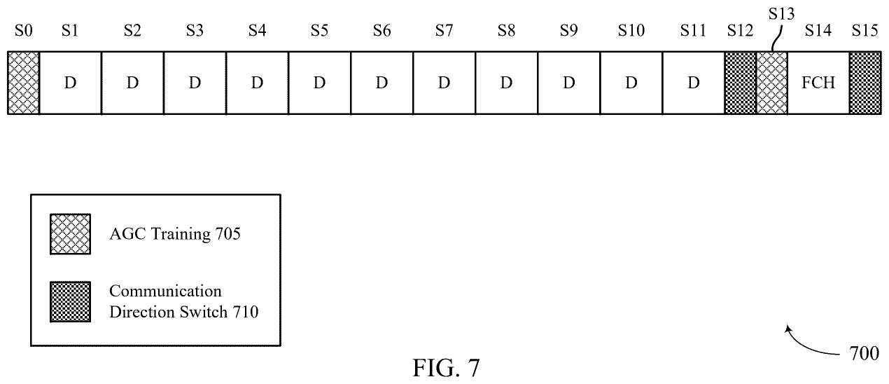

FIG. 7 shows an example of a mixed numerology slot structure 700 for sidelink communication in accordance with one or more aspects of the present disclosure. The mixed numerology slot structure 700 may implement or be implemented to realize one or more aspects of the present disclosure. For example, the mixed numerology slot structure 700 may be an example of the mixed numerology slot structure 310, as illustrated by and described with reference to FIG. 3. The mixed numerology slot structure 700 may define a PSFCH slot and may include two symbols (e.g., S0 and S13) associated with AGC training 705 and two symbols (e.g., S12 and S15) associated with a communication direction switch 710.

In accordance with the mixed numerology slot structure 700, S0 and S13 may use a doubled SCS size (e.g., relative to a baseline SCS, such as a lowest SCS associated with the mixed numerology slot structure 700) with S12 and S15 (e.g., guard symbols) being empty symbols with a same duration as S0 and S13. In other words, S0 and S13 may be associated with a first SCS, S1-S11 and S14 may be associated with a second SCS, and S12 and S15 may have a duration associated with (e.g., defined by) the first SCS. In accordance with such aspects of the mixed numerology slot structure 700, a slot defined in accordance with the mixed numerology slot structure 700 may include 11 unique data symbols.

In some aspects, a UE 115 (e.g., the UE 115-a) may generate S0 as a duplication of a subset of subcarriers of S1. For example, the UE 115 may generate s0 as a duplication of the even or odd subcarriers of S1. A UE 115 may use S0 (e.g., an AGC symbol) as a power reference signal, such as for AGC computation. In accordance with the generation of S0 as being the even or odd subcarriers of S1, S0 power may represent S1 power. Additionally, or alternatively, a UE 115 may use S0 to carry some amount of duplicated data. For example, a UE 115 may use subcarriers of S0 to carry a subset of a set of data conveyed via S1. In such examples, if a gain state is not changed over S0, a receiving UE 115 may generate LLRs of S0 and combine the generated LLRs with, for example, one-half of the LLRs of S1.

In some aspects, a UE 115 may use S13 for AGC training 705 of a PSFCH signal. In such aspects, S13 may be a duplication of S14 in RE level, with, for example, odd or even dilution. Such a partial duplication of S14 in RE level in S13 may be sufficient to facilitate high performance of the AGC at the receiving UE 115. A UE 115 may transmit a PSFCH signal within S14. A UE 115 that transmits a PSFCH signal may perform the PSFCH signal transmission via a predefined resource block (RB). In some examples, different UEs 115 may transmit PSFCH signals via different RBs, sometimes leaving a partially empty allocation within S14. In such examples, dilution in RB level may not be possible, as it may not accurately or truthfully represent a power spectral density.

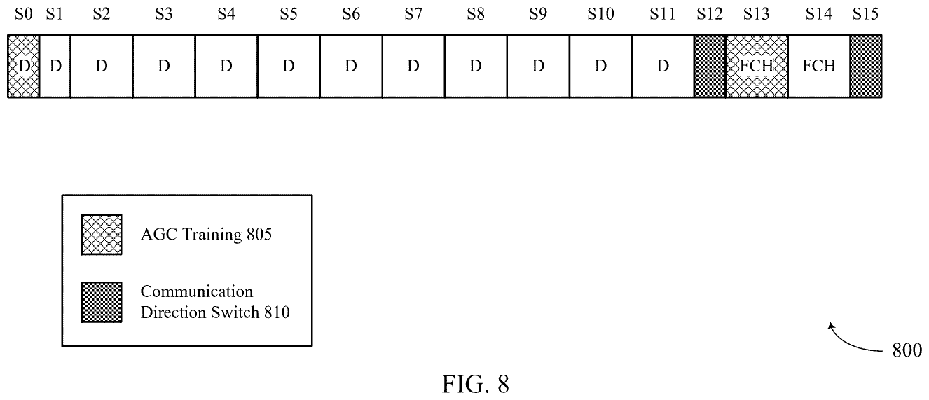

FIG. 8 shows an example of a mixed numerology slot structure 800 for sidelink communication in accordance with one or more aspects of the present disclosure. The mixed numerology slot structure 800 may implement or be implemented to realize one or more aspects of the present disclosure. For example, the mixed numerology slot structure 800 may be an example of the mixed numerology slot structure 310, as illustrated by and described with reference to FIG. 3. The mixed numerology slot structure 800 may define a PSFCH slot and may include two symbols (e.g., S0 and S13) associated with AGC training 805 and two symbols (e.g., S12 and S15) associated with a communication direction switch 810.

In accordance with the mixed numerology slot structure 800, S0 and S1 may use a doubled SCS size (e.g., relative to a baseline SCS, such as a lowest SCS associated with the mixed numerology slot structure 800) with S12 and S15 (e.g., guard symbols) being empty symbols with a same duration as S0 and S1. In other words, S0 and S1 may be associated with a first SCS, S2-S11, S13, and S14 may be associated with a second SCS, and S12 and S15 may have a duration associated with (e.g., defined by) the first SCS. In accordance with such aspects of the mixed numerology slot structure 800, a slot defined in accordance with the mixed numerology slot structure 800 may include 11 unique data symbols with S0 and S1 carrying or including approximately one-half (e.g., ×0.5) a quantity of subcarriers compared to other data symbols. In such aspects, a slot defined in accordance with the mixed numerology slot structure 800 may effectively include 10.5 unique data symbols associated with the baseline SCS. In some aspects, a UE 115 may refrain from deriving, calculating, or otherwise determining channel estimation from S0 and S1, as such channel estimation may increase complexity due to the difference SCS size between symbols. Instead, in some aspects, the UE 115 may extrapolate the channel estimation of S0 and S1 from the baseline SCS size symbols (e.g., S2-S11).

In some aspects, S0 (e.g., an AGC symbol) may be a duplication of S1, which may facilitate lower complexity for a UE 115 transmitting a slot in accordance with the mixed numerology slot structure 800. A UE 115 receiving the slot may use S0 for message decoding, which my improve performance in scenarios in which an AGC state has not changed, in aspects in which S0 is a duplication of S1 (e.g., by LLR combining). In some aspects, S13 (e.g., a PSFCH AGC symbol) may be a duplication of S14 and may be associated with the baseline SCS size.

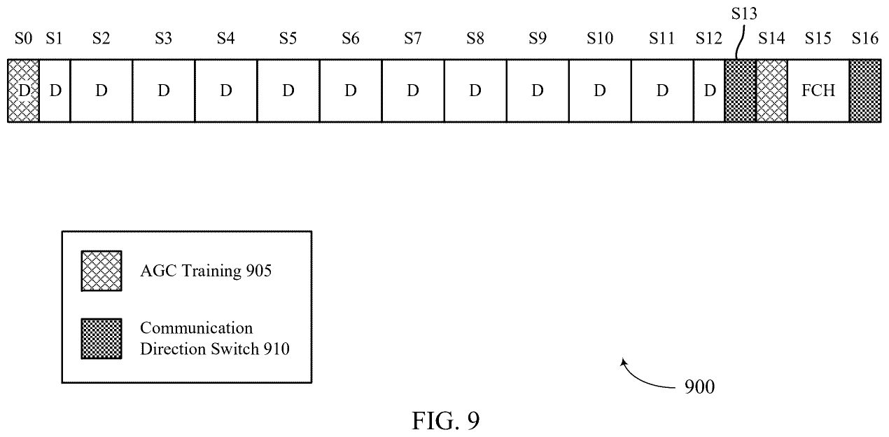

FIG. 9 shows an example of a mixed numerology slot structure 900 for sidelink communication in accordance with one or more aspects of the present disclosure. The mixed numerology slot structure 900 may implement or be implemented to realize one or more aspects of the present disclosure. For example, the mixed numerology slot structure 900 may be an example of the mixed numerology slot structure 310, as illustrated by and described with reference to FIG. 3. The mixed numerology slot structure 900 may define a PSFCH slot and may include two symbols (e.g., S0 and S14) associated with AGC training 905 and two symbols (e.g., S13 and S16) associated with a communication direction switch 910.

In accordance with the mixed numerology slot structure 900, S0, S1, S12, and S14 may use doubled SCS (e.g., relative to a baseline SCS, such as a lowest SCS associated with the mixed numerology slot structure 900) with S13 and S16 (e.g., guard symbols) being empty symbols with a same duration as S0, S1, S12, and S14. In other words, S0, S1, S12, and S14 may be associated with a first SCS, S2-S11 and S15 may be associated with a second SCS, and S13 and S16 may have a duration associated with the first SCS. In accordance with such aspects of the mixed numerology slot structure 900, a slot defined in accordance with the mixed numerology slot structure 900 may include 12 unique data symbols with two symbols (e.g., S1 and S12) using double SCS size. Because two symbols use double SCS size, a total amount of information conveyed via a slot defined by the mixed numerology slot structure 900 may be approximately the same as if the slot were defined by the mixed numerology slot structure 700. S0, S1, and S12 may carry or include approximately one-half (e.g., ×0.5) a quantity of subcarriers as compared to other data symbols (e.g., S2-S11).

In some aspects, S0 (e.g., an AGC symbol) may be a duplication of S1, which may facilitate lower complexity for a UE 115 transmitting a slot in accordance with the mixed numerology slot structure 900. A UE 115 receiving the slot may use S0 for message decoding, which my improve performance in scenarios in which an AGC state has not changed, in aspects in which S0 is a duplication of S1 (e.g., by LLR combining).

In some aspects, a UE 115 may use S14 for AGC training 905 of a PSFCH signal. In such aspects, S14 may be a duplication of S15 in RE level, with, for example, odd or even dilution. Such a partial duplication of S15 in RE level in S14 may be sufficient to facilitate high performance of the AGC at the receiving UE 115. A UE 115 may transmit a PSFCH signal within S15. A UE 115 that transmits a PSFCH signal may perform the PSFCH signal transmission via a predefined RB. In some examples, different UEs 115 may transmit PSFCH signals via different RBs, sometimes leaving a partially empty allocation within S15. In such examples, dilution in RB level may not be possible, as it may not accurately or truthfully represent a power spectral density.

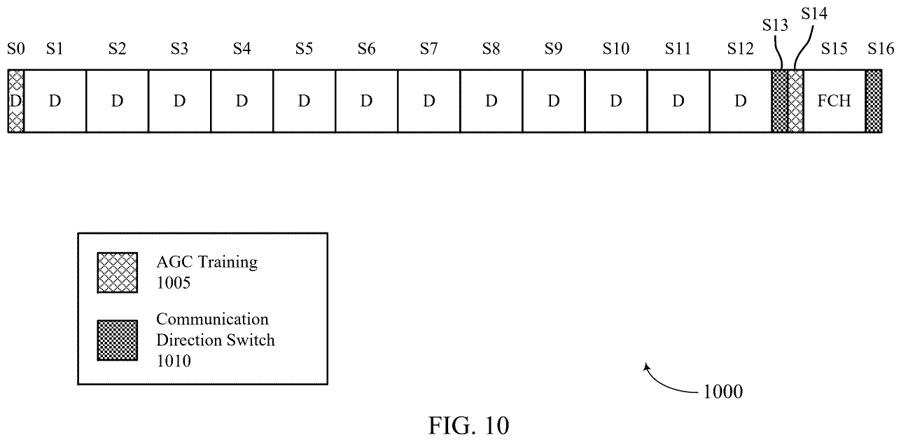

FIG. 10 shows an example of a mixed numerology slot structure 1000 for sidelink communication in accordance with one or more aspects of the present disclosure. The mixed numerology slot structure 1000 may implement or be implemented to realize one or more aspects of the present disclosure. For example, the mixed numerology slot structure 1000 may be an example of the mixed numerology slot structure 310, as illustrated by and described with reference to FIG. 3. The mixed numerology slot structure 1000 may define a PSFCH slot and may include two symbols (e.g., S0 and S14) associated with AGC training 1005 and two symbols (e.g., S13 and S16) associated with a communication direction switch 1010.

In accordance with the mixed numerology slot structure 1000, S0 and S14 may use quadrupled SCS size (e.g., relative to a baseline SCS, such as a lowest SCS associated with the mixed numerology slot structure 1000) with S13 and S16 being empty symbols with a same duration as S0 and S14. In other words, S0 and S14 may be associated with a first SCS, S1-S12 and S15 may be associated with a second SCS, and S13 and S16 may have a duration associated with the first SCS. In accordance with such aspects of the mixed numerology slot structure 1000, a slot defined in accordance with the mixed numerology slot structure 1000 may include 12 unique data symbols (of a baseline, or original, SCS size).

In some aspects, a UE 115 may use S0 (e.g., an AGC symbol) as a power reference signal (e.g., exclusively for AGC computation) or as a duplication of S1 by using a dilution of subcarriers or REs. For example, in aspects in which S0 is associated with a quadrupled SCS as compared to the SCS of S1, S0 may be a duplication of S1 by using a dilution of 1:4 subcarriers or REs (such that S0 includes approximately one-fourth of the subcarriers or REs as S1). S14 may be used for AGC training 1005 of the PSFCH signal with a power reference signal, such as by duplication of S15 with a 1:4 RE dilution. In some aspects, such a generation of S14 may result in sufficient receive side AGC performance. A UE 115 may transmit a PSFCH signal within S15. A UE 115 that transmits a PSFCH signal may perform the PSFCH signal transmission via a predefined RB. In some examples, different UEs 115 may transmit PSFCH signals via different RBs, sometimes leaving a partially empty allocation within S15. In such examples, dilution in RB level may not be possible, as it may not accurately or truthfully represent a power spectral density.

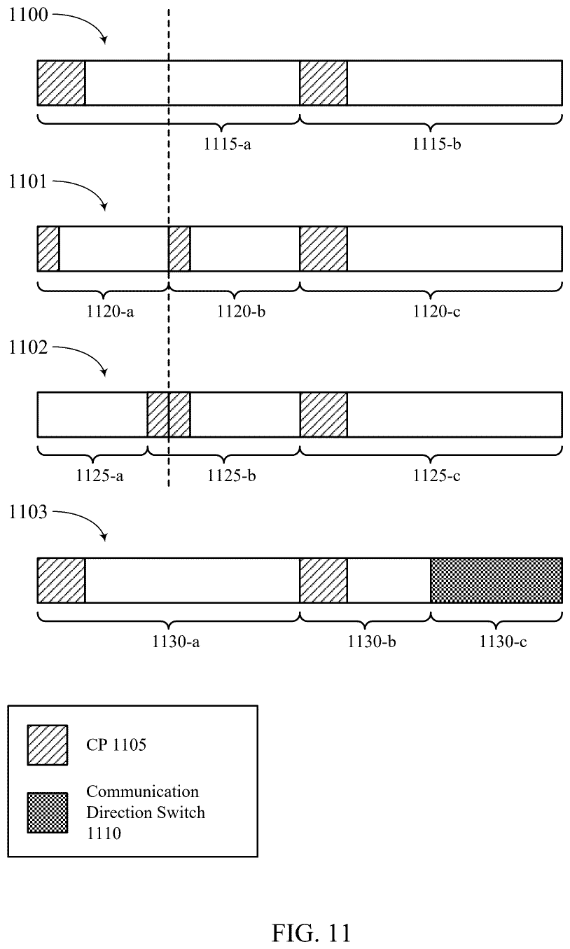

FIG. 11 shows examples of CP placements 1100, 1101, 1102, and 1103 that support a mixed numerology slot structure for sidelink communication in accordance with one or more aspects of the present disclosure. One or more of the CP placements 1100, 1101, 1102, or 1103 may implement or be implemented to realize one or more aspects of the present disclosure. For example, one or both of the UE 115-a or the UE 115-b may use one or more of the CP placements 1100, 1101, 1102, or 1103 in association with transmitting or receiving within one or more symbols of the slot 315 associated with the mixed numerology slot structure 310.

In some systems, a UE 115 may select or configure a CP duration as part of selecting or configuring a symbol duration. A CP duration may be approximately proportional to the symbol duration. For example, a CP duration may be approximately 7% of the symbol duration. For sidelink communication (e.g., V2X communication), one or more UEs 115 may use a relatively longer CP to cope with channel impairments and to absorb different sources of propagation delays and timing misalignments. For example, the CP may mitigate or address challenges arising in scenarios in which different UEs 115 may have highly varied delays or highly varied channel properties, among other examples. In some aspects, a slot structure (e.g., the mixed numerology slot structure 310) may account for such usage of CPs in sidelink communication.

If a slot includes two consecutive larger SCS size symbols with a fixed CP to symbol size ratio, the CPs within the two consecutive larger SCS size symbols may sometimes become too short and may no longer aid with the delays or timing misalignments that may arise in some sidelink communications systems. For example, if the two consecutive larger SCS size symbols have a doubled SCS relative to a baseline SCS of other symbols within the same slot, the CP for the two consecutive larger SCS size symbols may be shortened by half, which may sometimes be insufficient to aid with delays or timing misalignments. Accordingly, some example aspects of the present disclosure may leverage any one or more of the CP placements 1100, 1101, 1102, or 1103 to support varying symbol durations within a slot while still enabling CPs to aid with the delays or timing misalignments that may arise in some sidelink communications systems.

In accordance with the CP placement 1100, a first symbol 1115-a and a second symbol 1115-b may each include a CP 1105 having a same duration. In other words, a first CP 1105 of the first symbol 1115-a may have a same duration as a second CP 1105 of the second symbol 1115-b. The CP placement 1100 may represent or be associated with a baseline CP placement or configuration. In some aspects, for example, the first symbol 1115-a and the second symbol 1115-b may be examples of two data symbols associated with a baseline SCS within a slot associated with a mixed numerology slot structure.

In accordance with the CP placement 1101, a first symbol 1120-a and a second symbol 1120-b may each include a CP 1105 having a first duration and a third symbol 1120-c may include a CP 1105 having a second duration. In some aspects, the first symbol 1120-a and the second symbol 1120-b may be associated with a doubled SCS (and one-half a symbol duration) as compared to the third symbol 1120-c and, in accordance with the CP placement 1101, the first CP duration of the first symbol 1120-a and the second symbol 1120-b may be one-half the second CP duration of the third symbol 1120-c. In other words, the CP durations across the first symbol 1120-a, the second symbol 1120-b, and the third symbol 1120-c may be associated with or based on a fixed CP to symbol size ratio. In some aspects, one or more UEs 115 may use the CP placement 1101 in accordance with satisfying one or more conditions, such as in accordance with a measured, predicted, calculated, or otherwise determined delay or timing misalignment being below a threshold delay or timing misalignment. If at least one UE 115 uses a given CP placement, some systems may expect that all UEs 115 within the system use the same CP placement.

In accordance with the CP placement 1102, a first symbol 1125-a may exclude a CP 1105 and a second symbol 1125-b and a third symbol 1125-c may each include a CP 1105 having a same duration. In other words, a UE 115 may remove the CP 1105 from the first symbol 1125-a and may use a baseline SCS symbol CP duration for the second symbol 1125-b, with the first symbol 1125-a and the second symbol 1125-b being associated with a doubled SCS as compared to the third symbol 1125-c. In some aspects, a UE 115 may use the first symbol 1125-a (the symbol without a CP 1105) for AGC training (such as exclusively for AGC training). By providing a CP 1105 within the second symbol 1125-b having a duration associated with a baseline SCS, the second symbol 1125-b may experience relatively less inter-symbol interference while still being associated with a doubled SCS (as compared to the baseline SCS of the third symbol 1125-c).

In accordance with the CP placement 1103, a first symbol 1130-a and a second symbol 1130-b may be associated with a CP 1105 having a same duration and a third symbol 1130-c may be absent of a CP 1105. In some aspects, the third symbol 1130-c may be associated with a communication direction switch 1110. In some aspects, the second symbol 1130-b and the third symbol 1130-c may be associated with a doubled SCS as compared to a baseline SCS of the first symbol 1130-a. In such aspects, the second symbol 1130-b may be associated with the doubled SCS (such that the data subcarriers or REs of the second symbol 1130-b are associated with the doubled SCS) and may include a CP 1105 having a duration associated with the baseline SCS. By providing a CP 1105 within the second symbol 1130-b having a duration associated with the baseline SCS, the second symbol 1130-b may experience relatively less inter-symbol interference while still being associated with a doubled SCS (as compared to the baseline SCS of the first symbol 1130-a). The second symbol 1130-b and the third symbol 1130-c may be examples of S14 and S15, respectively, in some aspects.

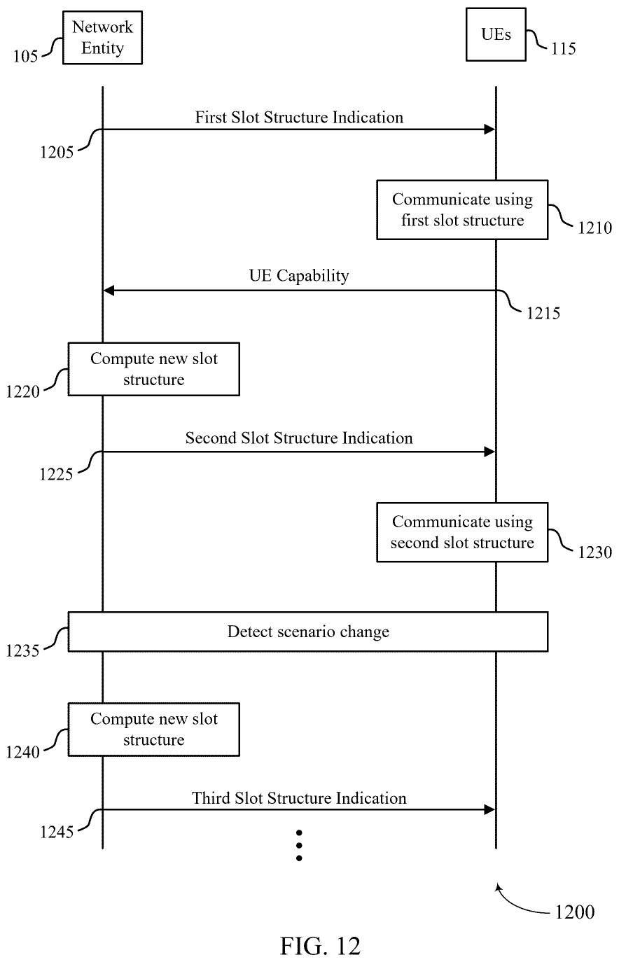

FIG. 12 shows an example of a process flow 1200 that supports a mixed numerology slot structure for sidelink communication in accordance with one or more aspects of the present disclosure. The process flow 1200 may implement or be implemented to realize one or more aspects of the present disclosure. For example, the process flow 1200 illustrates communication between one or more UEs 115 and a network entity 105, which may be examples of corresponding devices described herein. In some aspects, the network entity 105 may transmit an indication of a slot structure for sidelink communication to the one or more UEs 115 and, in association with receiving the indication of the slot structure, the one or more UEs 115 may perform sidelink communication in accordance with the slot structure. The indicated slot structure may be a uniform numerology slot structure or a mixed numerology slot structure. In some aspects, the network entity 105 may provide such signaling indicative of a slot structure for sidelink communication in some sidelink modes (e.g., sidelink mode 1).

In the following description of the process flow 1200, the operations may be performed (e.g., reported or provided) in a different order than the order shown, or the operations performed by the example devices may be performed in different orders or at different times. Some operations also may be left out of the process flow 1200, or other operations may be added to the process flow 1200. Further, although some operations or signaling may be shown to occur at different times for discussion purposes, these operations may actually occur at the same time.

At 1205, the network entity 105 may transmit, to one or more UEs 115, an indication of a first slot structure for the one or more UEs 115 to use for sidelink communication. The first slot structure may be a uniform numerology slot structure or a mixed numerology slot structure. The one or more UEs 115 may receive the indication of the first slot structure as an instruction to use the first slot structure or as an instruction to switch to the first slot structure (immediately or at some indicted or defined future time). The UEs 115 may receive the indication of the first slot structure via downlink control information (DCI), one or more MAC control elements (MAC-CEs), RRC signaling, or any combination thereof.

At 1210, the one or more UEs 115 may communicate in accordance with the first slot structure. For example, the UE(s) 115 may transmit sidelink signaling within one or more symbols of a slot associated with the first slot structure.

At 1215, one or more UEs 115 may transmit information indicative of respective UE capabilities to the network entity 105. In some aspects, the UE capabilities provided to the network entity 105 may indicate information associated with supporting one or more mixed numerology slot structures for sidelink communication. In such aspects, each UE 115 of the one or more UEs 115 may indicate one or more specific mixed numerology slot structures that the UE 115 supports, whether the UE 115 supports one or both of mixed numerology slot structures or uniform numerology slot structures, a quantity of different mixed numerology slot structures that the UE 115 supports, whether the UE 115 supports switching between mixed numerology slot structures and uniform numerology slot structures, or any combination thereof. Each UE 115 of the one or more UEs 115 may transmit such information indicative of the respective UE capabilities via uplink control information (UCI), one or more MAC-CEs, RRC signaling, or any combination thereof.

At 1220, the network entity 105 may compute (e.g., select, identify, calculate, generate, configure, or otherwise determine) a new slot structure in accordance with the respective UE capabilities received at 1215. In some aspects, for example, the network entity 105 may compute a slot structure that complies with capabilities of the one or more UEs 115 (e.g., a slot structure that complies with a most limited capability of the one or more UEs 115). In some aspects, the network entity 105 may compute the new slot structure as a second slot structure.

At 1225, the network entity 105 may transmit an indication of the second slot structure to the one or more UEs 115. The second slot structure may be a uniform numerology slot structure or a mixed numerology slot structure. The one or more UEs 115 may receive the indication of the second slot structure as an instruction to use the second slot structure or as an instruction to switch to the second slot structure (immediately or at some indicted or defined future time). The UEs 115 may receive the indication of the second slot structure via DCI, one or more MAC-CEs, RRC signaling, or any combination thereof.

At 1230, the one or more UEs 115 may communicate in accordance with the second slot structure. For example, the UE(s) 115 may transmit sidelink signaling within one or more symbols of a slot associated with the second slot structure.

At 1235, the network entity 105 or one or more UEs 115 may detect a scenario change. In some aspects, the network entity 105 or one or more UEs 115 may detect the scenario change and transmit information indicative of (e.g., a notification of) the scenario change. The scenario change may be any change in the operation, or operating conditions, of the one or more UEs 115, such as a change in interference (e.g., inter-symbol interference), a change in propagation delay, a change in channel properties, a change in timing misalignments, or any combination thereof. Additionally, or alternatively, the scenario change may be associated with a relative proximity of a set of UEs 115 to each other, or a change in a connectivity of a set of UEs 115 to the network.

At 1240, the network entity 105 may compute (e.g., select, identify, calculate, generate, configure, or otherwise determine) a new slot structure in accordance with the scenario change. For example, if a group of UEs, forming a network, are relatively close to each other (e.g., within a threshold distance) at a time period, the network entity 105 may compute a mixed numerology slot structure (as, for example, a shorter CP may be sufficient for propagation delays and other effects). By way of further example, if a group of UEs, forming a network, are relatively far apart (e.g., greater than a threshold distance) at a time period, the network entity 105 may compute a uniform numerology slot structure (as, for example, a longer CP may be suitable to absorb propagation delays and other effects). In some aspects, the network entity 105 may compute a first slot structure for a first group of UEs 115 and a second slot structure for a second group of UEs 115 for a same time period. Additionally, or alternatively, the network entity 105 may compute a first slot structure for a group of UEs 115 for a first time period and may compute a second slot structure for the same group of UEs 115 for a second time period (e.g., in accordance with changing capabilities or changing scenarios). By way of example, the network entity 105 may compute the new slot structure at 1240 as a third slot structure.

At 1245, the network entity 105 may transmit an indication of the third slot structure to the one or more UEs 115. The third slot structure may be a uniform numerology slot structure or a mixed numerology slot structure. The one or more UEs 115 may receive the indication of the third slot structure as an instruction to use the third slot structure or as an instruction to switch to the third slot structure (immediately or at some indicted or defined future time). The UEs 115 may receive the indication of the third slot structure via DCI, one or more MAC-CEs, RRC signaling, or any combination thereof. The network entity 105 and the UEs 115 may re-perform one or more of the above-described operations. For example, there may be one or more additional scenario changes that the network entity 105 and/or the UEs 115 may detect and the network entity 105 may compute a new slot structure (e.g., a fourth slot structure, a fifth slot structure, etc.) and may provide an indication of the new slot structure to the UEs 115.

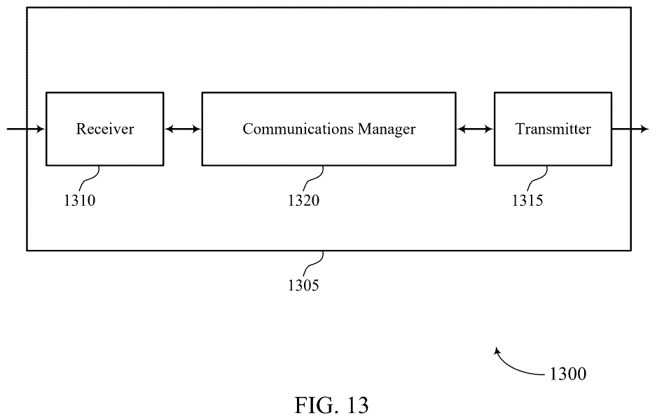

FIG. 13 shows a block diagram 1300 of a device 1305 that supports mixed numerology slot structure for sidelink communication in accordance with one or more aspects of the present disclosure. The device 1305 may be an example of aspects of a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to mixed numerology slot structure for sidelink communication). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to mixed numerology slot structure for sidelink communication). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations or components thereof may be examples of means for performing various aspects of mixed numerology slot structure for sidelink communication as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication in accordance with examples as disclosed herein. For example, the communications manager 1320 is capable of, configured to, or operable to support a means for communicating (e.g., transmitting or receiving), within a first set of one or more symbols of a slot associated with a mixed numerology sidelink slot structure, first sidelink signaling in accordance with a first SCS. The communications manager 1320 is capable of, configured to, or operable to support a means for communicating (e.g., transmitting or receiving), within a second set of one or more symbols of the slot associated with the mixed numerology sidelink slot structure, second sidelink signaling in accordance with a second SCS different from the first SCS.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for more efficient utilization of communication resources, higher throughput, and greater spectral efficiency.

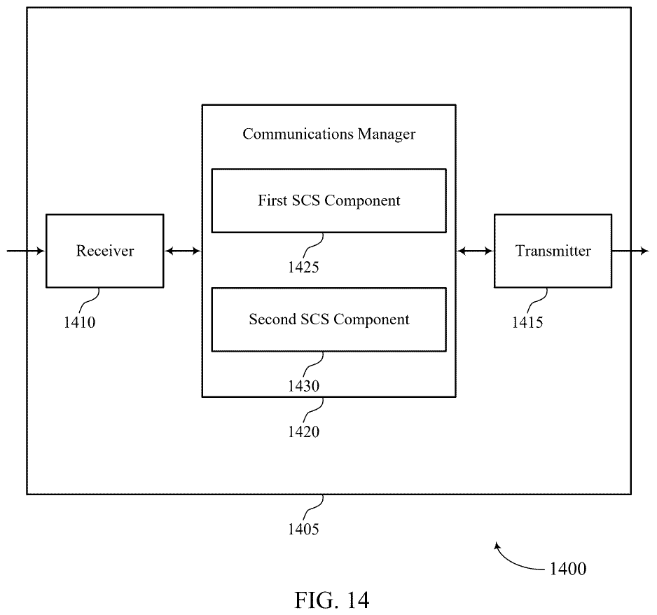

FIG. 14 shows a block diagram 1400 of a device 1405 that supports mixed numerology slot structure for sidelink communication in accordance with one or more aspects of the present disclosure. The device 1405 may be an example of aspects of a device 1305 or a UE 115 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for receiving information such as packets, user data, control information, or any combination thereof associated with various information channels (e.g., control channels, data channels, information channels related to mixed numerology slot structure for sidelink communication). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to mixed numerology slot structure for sidelink communication). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of mixed numerology slot structure for sidelink communication as described herein. For example, the communications manager 1420 may include a first SCS component 1425 a second SCS component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication in accordance with examples as disclosed herein. The first SCS component 1425 is capable of, configured to, or operable to support a means for communicating (e.g., transmitting or receiving), within a first set of one or more symbols of a slot associated with a mixed numerology sidelink slot structure, first sidelink signaling in accordance with a first SCS. The second SCS component 1430 is capable of, configured to, or operable to support a means for communicating (e.g., transmitting or receiving), within a second set of one or more symbols of the slot associated with the mixed numerology sidelink slot structure, second sidelink signaling in accordance with a second SCS different from the first SCS.

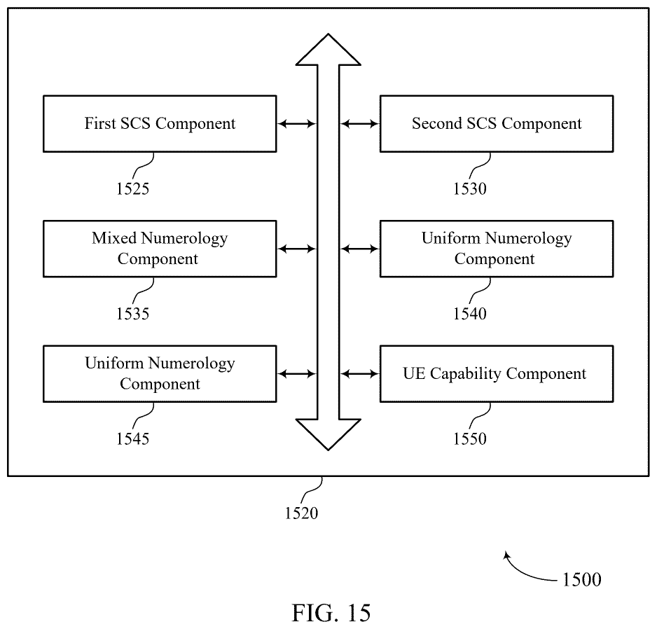

FIG. 15 shows a block diagram 1500 of a communications manager 1520 that supports mixed numerology slot structure for sidelink communication in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of mixed numerology slot structure for sidelink communication as described herein. For example, the communications manager 1520 may include a first SCS component 1525, a second SCS component 1530, a mixed numerology component 1535, a uniform numerology component 1540, a uniform numerology component 1545, a UE capability component 1550, or any combination thereof. Each of these components, or components or subcomponents thereof (e.g., one or more processors, one or more memories), may communicate, directly or indirectly, with one another (e.g., via one or more buses).

The communications manager 1520 may support wireless communication in accordance with examples as disclosed herein. The first SCS component 1525 is capable of, configured to, or operable to support a means for communicating (e.g., transmitting or receiving), within a first set of one or more symbols of a slot associated with a mixed numerology sidelink slot structure, first sidelink signaling in accordance with a first SCS. The second SCS component 1530 is capable of, configured to, or operable to support a means for communicating (e.g., transmitting or receiving), within a second set of one or more symbols of the slot associated with the mixed numerology sidelink slot structure, second sidelink signaling in accordance with a second SCS different from the first SCS.

In some examples, the mixed numerology sidelink slot structure is associated with two or more SCSs including the first SCS and the second SCS. In some examples, the mixed numerology sidelink slot structure defines that one or more first symbols of the slot associated with automatic gain control and one or more second symbols of the slot associated with a communication direction switch have a duration associated with a largest SCS of the two or more SCSs.

In some examples, remaining symbols of the slot outside of the one or more first symbols associated with the automatic gain control and the one or more second symbols associated with the communication direction switch are associated with any combination of one or more of the two or more SCSs.

In some examples, the one or more first symbols associated with the automatic gain control and the remaining symbols have a same power spectrum density.

In some examples, the UE generates a first symbol of the slot associated with automatic gain control in accordance with a subsequent symbol of the slot that is adjacent to the first symbol.

In some examples, the first symbol is a duplication of the subsequent symbol in accordance with the first symbol and the subsequent symbol being associated with a same SCS.

In some examples, the subsequent symbol includes a set of populated subcarriers. In some examples, the first symbol includes a uniformly distributed subset of populated subcarriers from the set of populated subcarriers.

In some examples, the uniformly distributed subset of populated subcarriers within the first symbol is selected from the set of populated subcarriers within the subsequent symbol at a rate associated with a difference in SCS between the first symbol and the subsequent symbol.

In some examples, the mixed numerology sidelink slot structure defines that an initial symbol of the slot is associated with the first SCS; a last symbol of the slot is associated with a communication direction switch and has a duration associated with the first SCS; and a remainder of symbols of the slot is associated with the second SCS.

In some examples, the first SCS is equal to double the second SCS. In some examples, the slot includes thirteen unique data symbols in accordance with the mixed numerology sidelink slot structure.

In some examples, an initial data symbol of the thirteen unique data symbols includes a first set of populated subcarriers in a frequency domain. In some examples, the initial symbol of the slot includes a duplication of a subset of the first set of populated subcarriers in the frequency domain.

In some examples, the slot includes fifteen symbols in accordance with the mixed numerology sidelink slot structure.

In some examples, the mixed numerology sidelink slot structure defines that an initial symbol, a second symbol subsequent to the initial symbol, and a penultimate symbol of the slot are associated with the first SCS; a last symbol of the slot is associated with a communication direction switch and has a duration associated with the first SCS; and a remainder of symbols of the slot is associated with the second SCS.

In some examples, the first SCS is equal to double the second SCS. In some examples, the slot includes fourteen unique data symbols in accordance with the mixed numerology sidelink slot structure.

In some examples, the initial symbol is a duplication of the second symbol. In some examples, the second symbol is an initial data symbol of the fourteen unique data symbols.

In some examples, the slot includes sixteen symbols in accordance with the mixed numerology sidelink slot structure.

In some examples, the mixed numerology sidelink slot structure defines that an initial symbol, a second symbol subsequent to the initial symbol, and a penultimate symbol of the slot are associated with the first SCS; a last symbol of the slot is associated with a communication direction switch and has a duration associated with the first SCS; a third symbol subsequent to the second symbol and a symbol prior to the penultimate symbol of the slot are associated with the second SCS; and a remainder of symbols of the slot is associated with a third SCS different from the first SCS and the second SCS.

In some examples, the first SCS is equal to quadruple the third SCS. In some examples, the second SCS is equal to double the third SCS. In some examples, the slot includes sixteen unique data symbols in accordance with the mixed numerology sidelink slot structure.

In some examples, the initial symbol is a duplication of the second symbol. In some examples, the second symbol is an initial data symbol of the sixteen unique data symbols.

In some examples, the slot includes seventeen symbols in accordance with the mixed numerology sidelink slot structure.

In some examples, the mixed numerology sidelink slot structure defines that an initial symbol and a symbol prior to a feedback symbol of the slot are associated with the first SCS; another symbol prior to the above latter symbol and a last symbol of the slot are associated with a communication direction switch and each have a duration associated with the first SCS; and a remainder of symbols of the slot is associated with the second SCS.

In some examples, the first SCS is equal to double the second SCS. In some examples, the slot includes eleven unique data symbols and one feedback symbol in accordance with the mixed numerology sidelink slot structure.

In some examples, the slot includes sixteen symbols in accordance with the mixed numerology sidelink slot structure.

In some examples, the mixed numerology sidelink slot structure defines that an initial symbol and a second symbol subsequent to the initial symbol of the slot are associated with the first SCS; a symbol prior to an initial feedback symbol and a last symbol of the slot are associated with a communication direction switch and each have a duration associated with the first SCS; and a remainder of symbols of the slot is associated with the second SCS.

In some examples, the first SCS is equal to double the second SCS. In some examples, the slot includes eleven unique data symbols and two feedback symbols in accordance with the mixed numerology sidelink slot structure.

In some examples, the slot includes sixteen symbols in accordance with the mixed numerology sidelink slot structure.

In some examples, the mixed numerology sidelink slot structure defines that an initial symbol, a second symbol subsequent to the initial symbol, a thirteenth symbol, and a fifteenth symbol prior to a feedback symbol of the slot are associated with the first SCS; a fourteenth symbol and a last symbol of the slot are associated with a communication direction switch and each have a duration associated with the first SCS; and a remainder of symbols of the slot is associated with the second SCS.

In some examples, the first SCS is equal to double the second SCS. In some examples, the slot includes twelve unique data symbols and one feedback symbol in accordance with the mixed numerology sidelink slot structure.

In some examples, the slot includes seventeen symbols in accordance with the mixed numerology sidelink slot structure.

In some examples, the mixed numerology sidelink slot structure defines that an initial symbol and a symbol prior to a feedback symbol of the slot are associated with the first SCS; another symbol prior to the above latter symbol and a last symbol of the slot are associated with a communication direction switch and each have a duration associated with the first SCS; and a remainder of symbols of the slot is associated with the second SCS.

In some examples, the first SCS is equal to quadruple the second SCS. In some examples, the slot includes twelve unique data symbols and one feedback symbol in accordance with the mixed numerology sidelink slot structure.

In some examples, the slot includes seventeen symbols in accordance with the mixed numerology sidelink slot structure.

In some examples, each symbol of the first set of one or more symbols includes a first cyclic prefix duration at a beginning of that symbol, the first cyclic prefix duration associated with a first symbol size that corresponds to the first SCS and a fixed cyclic prefix to symbol size ratio. In some examples, each symbol of the second set of one or more symbols includes a second cyclic prefix duration at a beginning of that symbol, the second cyclic prefix duration associated with a second symbol size that corresponds to the second SCS and the fixed cyclic prefix to symbol size ratio.

In some examples, the first set of one or more symbols includes two symbols, an initial symbol of the two symbols excluding a cyclic prefix and a second symbol of the two symbols including a cyclic prefix duration at a beginning of the second symbol, the cyclic prefix duration associated with a symbol size that corresponds to the second SCS. In some examples, each symbol of the second set of one or more symbols includes the cyclic prefix duration at a beginning of that symbol.

In some examples, the initial symbol of the two symbols is an automatic gain control training symbol.

In some examples, the first set of one or more symbols includes two symbols, an initial symbol of the two symbols including a cyclic prefix duration at a beginning of the initial symbol and a second symbol of the two symbols excluding a cyclic prefix, the cyclic prefix duration associated with a symbol size that corresponds to the second SCS. In some examples, each symbol of the second set of one or more symbols includes the cyclic prefix duration at a beginning of that symbol.

In some examples, the second symbol of the two symbols is associated with a communication direction switch.

In some examples, the mixed numerology component 1535 is capable of, configured to, or operable to support a means for receiving an indication of the mixed numerology sidelink slot structure, where transmission in accordance with the mixed numerology sidelink slot structure is in association with reception of the indication of the mixed numerology sidelink slot structure.

In some examples, the UE capability component 1550 is capable of, configured to, or operable to support a means for transmitting information indicative of a capability of the UE associated with one or more mixed numerology sidelink slot structures, where reception of the indication of the mixed numerology sidelink slot structure is in association with transmission of the information indicative of the capability of the UE.

In some examples, the UE receives the indication of the mixed numerology sidelink slot structure as an instruction to switch to the mixed numerology sidelink slot structure from another mixed numerology sidelink slot structure.

In some examples, the UE receives the indication of the mixed numerology sidelink slot structure as an instruction to switch to the mixed numerology sidelink slot structure from a uniform numerology sidelink slot structure.

In some examples, the uniform numerology component 1540 is capable of, configured to, or operable to support a means for receiving an indication of a uniform numerology sidelink slot structure, where the UE receives the indication of the uniform numerology sidelink slot structure as an instruction to switch to the uniform numerology sidelink slot structure from the mixed numerology sidelink slot structure. In some examples, the uniform numerology component 1545 is capable of, configured to, or operable to support a means for communicating (e.g., transmitting or receiving), within symbols of a second slot associated with the uniform numerology sidelink slot structure, third sidelink signaling in accordance with a uniform SCS.

In some examples, the UE selects or receives an indication of the mixed numerology sidelink slot structure in accordance with a satisfaction of one or more conditions.

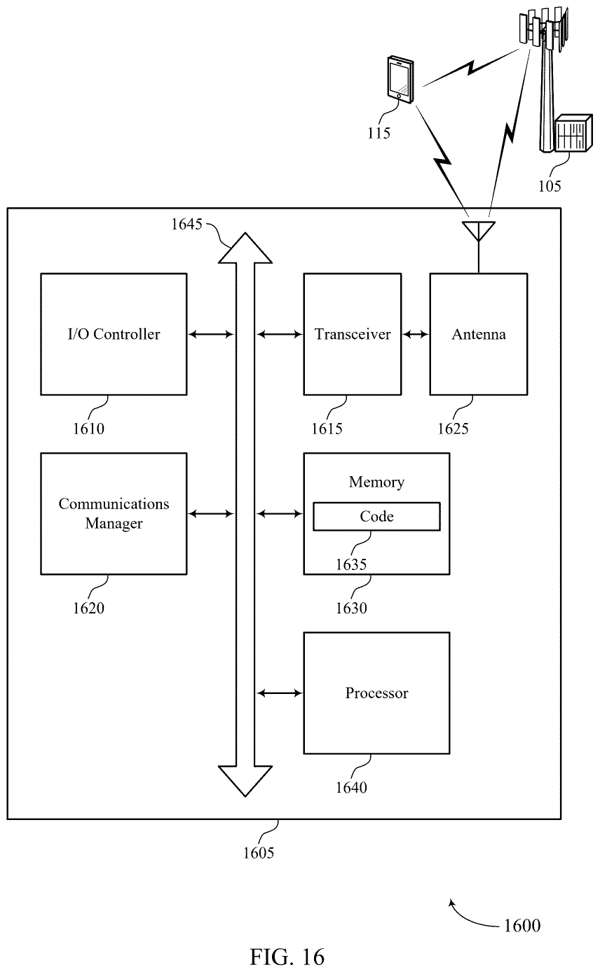

FIG. 16 shows a diagram of a system 1600 including a device 1605 that supports mixed numerology slot structure for sidelink communication in accordance with one or more aspects of the present disclosure. The device 1605 may be an example of or include components of a device 1305, a device 1405, or a UE 115 as described herein. The device 1605 may communicate (e.g., wirelessly) with one or more other devices (e.g., network entities 105, UEs 115, or a combination thereof). The device 1605 may include components for bi-directional voice and data communications including components for transmitting and receiving communications, such as a communications manager 1620, an input/output (I/O) controller, such as an I/O controller 1610, a transceiver 1615, one or more antennas 1625, at least one memory 1630, code 1635, and at least one processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally, or alternatively, the I/O controller 1610 may represent or interact with a modem, a keyboard, a mouse, a touchscreen, or a similar device. In some cases, the I/O controller 1610 may be implemented as part of one or more processors, such as the at least one processor 1640. In some cases, a user may interact with the device 1605 via the I/O controller 1610 or via hardware components controlled by the I/O controller 1610.

In some cases, the device 1605 may include a single antenna. However, in some other cases, the device 1605 may have more than one antenna, which may be capable of concurrently transmitting or receiving multiple wireless transmissions. The transceiver 1615 may communicate bi-directionally via the one or more antennas 1625 using wired or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The at least one memory 1630 may include random access memory (RAM) and read-only memory (ROM). The at least one memory 1630 may store computer-readable, computer-executable, or processor-executable code, such as the code 1635. The code 1635 may include instructions that, when executed by the at least one processor 1640, cause the device 1605 to perform various functions described herein. The code 1635 may be stored in a non-transitory computer-readable medium such as system memory or another type of memory. In some cases, the code 1635 may not be directly executable by the at least one processor 1640 but may cause a computer (e.g., when compiled and executed) to perform functions described herein. In some cases, the at least one memory 1630 may include, among other things, a basic I/O system (BIOS) which may control basic hardware or software operation such as the interaction with peripheral components or devices.

The at least one processor 1640 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1640 may be configured to operate a memory array using a memory controller. In some other cases, a memory controller may be integrated into the at least one processor 1640. The at least one processor 1640 may be configured to execute computer-readable instructions stored in a memory (e.g., the at least one memory 1630) to cause the device 1605 to perform various functions (e.g., functions or tasks supporting mixed numerology slot structure for sidelink communication). For example, the device 1605 or a component of the device 1605 may include at least one processor 1640 and at least one memory 1630 coupled with or to the at least one processor 1640, the at least one processor 1640 and the at least one memory 1630 configured to perform various functions described herein.

In some examples, the at least one processor 1640 may include multiple processors and the at least one memory 1630 may include multiple memories. One or more of the multiple processors may be coupled with one or more of the multiple memories, which may, individually or collectively, be configured to perform various functions described herein. In some examples, the at least one processor 1640 may be a component of a processing system, which may refer to a system (such as a series) of machines, circuitry (including, for example, one or both of processor circuitry (which may include the at least one processor 1640) and memory circuitry (which may include the at least one memory 1630)), or components, that receives or obtains inputs and processes the inputs to produce, generate, or obtain a set of outputs. The processing system may be configured to perform one or more of the functions described herein. For example, the at least one processor 1640 or a processing system including the at least one processor 1640 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code 1635 (e.g., processor-executable code) stored in the at least one memory 1630 or otherwise, to perform one or more of the functions described herein.

The communications manager 1620 may support wireless communication in accordance with examples as disclosed herein. For example, the communications manager 1620 is capable of, configured to, or operable to support a means for communicating (e.g., transmitting or receiving), within a first set of one or more symbols of a slot associated with a mixed numerology sidelink slot structure, first sidelink signaling in accordance with a first SCS. The communications manager 1620 is capable of, configured to, or operable to support a means for communicating (e.g., transmitting or receiving), within a second set of one or more symbols of the slot associated with the mixed numerology sidelink slot structure, second sidelink signaling in accordance with a second SCS different from the first SCS.

By including or configuring the communications manager 1620 in accordance with examples as described herein, the device 1605 may support techniques for improved communication reliability, reduced latency, more efficient utilization of communication resources, improved coordination between devices, and improved utilization of processing capability, among other benefits.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the at least one processor 1640, the at least one memory 1630, the code 1635, or any combination thereof. For example, the code 1635 may include instructions executable by the at least one processor 1640 to cause the device 1605 to perform various aspects of mixed numerology slot structure for sidelink communication as described herein, or the at least one processor 1640 and the at least one memory 1630 may be otherwise configured to, individually or collectively, perform or support such operations.

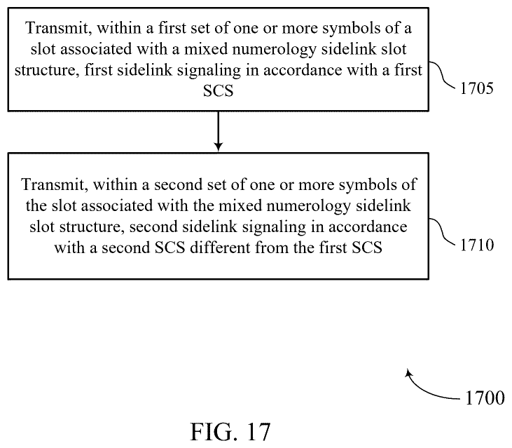

FIG. 17 shows a flowchart illustrating a method 1700 that supports mixed numerology slot structure for sidelink communication in accordance with one or more aspects of the present disclosure. The operations of the method 1700 may be implemented by a UE or its components as described herein. For example, the operations of the method 1700 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1705, the method may include transmitting, within a first set of one or more symbols of a slot associated with a mixed numerology sidelink slot structure, first sidelink signaling in accordance with a first SCS. The operations of 1705 may be performed in accordance with examples as disclosed herein, such as the transmission by the UE 115-a, within the first set of one or more symbols 320 of the slot 315 associated with the mixed numerology slot structure 310, first sidelink signaling in accordance with the first SCS 330, as illustrated by and described with reference to FIG. 3. The mixed numerology sidelink slot structure (equivalently referred to herein as a mixed numerology slot structure) may be the mixed numerology slot structure 400 of FIG. 4, the mixed numerology slot structure 500 of FIG. 5, the mixed numerology slot structure 600 of FIG. 6, the mixed numerology slot structure 700 of FIG. 7, the mixed numerology slot structure 800 of FIG. 8, the mixed numerology slot structure 900 of FIG. 9, or the mixed numerology slot structure 1000 of FIG. 10. In some examples, aspects of the operations of 1705 may be performed by a first SCS component 1525 as described with reference to FIG. 15.

At 1710, the method may include transmitting, within a second set of one or more symbols of the slot associated with the mixed numerology sidelink slot structure, second sidelink signaling in accordance with a second SCS different from the first SCS. The operations of 1710 may be performed in accordance with examples as disclosed herein, such as the transmission by the UE 115-a, within the second set of one or more symbols 325 of the slot 315 associated with the mixed numerology slot structure 310, second sidelink signaling in accordance with the second SCS 335, as illustrated by and described with reference to FIG. 3. In some examples, aspects of the operations of 1710 may be performed by a second SCS component 1530 as described with reference to FIG. 15.

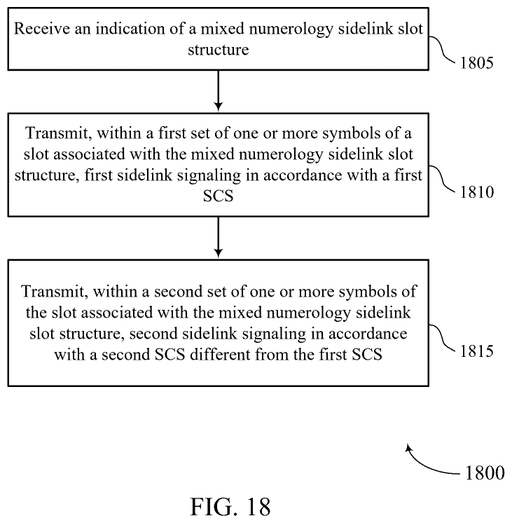

FIG. 18 shows a flowchart illustrating a method 1800 that supports mixed numerology slot structure for sidelink communication in accordance with one or more aspects of the present disclosure. The operations of the method 1800 may be implemented by a UE or its components as described herein. For example, the operations of the method 1800 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1805, the method may include receiving an indication of a mixed numerology sidelink slot structure. The operations of 1805 may be performed in accordance with examples as disclosed herein, such as in accordance with receiving an instruction from the network entity 105 at 1205, 1225, or 1245 of FIG. 12. The mixed numerology sidelink slot structure (equivalently referred to herein as a mixed numerology slot structure) may be the mixed numerology slot structure 400 of FIG. 4, the mixed numerology slot structure 500 of FIG. 5, the mixed numerology slot structure 600 of FIG. 6, the mixed numerology slot structure 700 of FIG. 7, the mixed numerology slot structure 800 of FIG. 8, the mixed numerology slot structure 900 of FIG. 9, or the mixed numerology slot structure 1000 of FIG. 10. In some examples, aspects of the operations of 1805 may be performed by a mixed numerology component 1535 as described with reference to FIG. 15.

At 1810, the method may include transmitting, within a first set of one or more symbols of a slot associated with the mixed numerology sidelink slot structure, first sidelink signaling in accordance with a first SCS. The operations of 1810 may be performed in accordance with examples as disclosed herein, such as the transmission, within the first set of one or more symbols 320 of the slot 315 associated with the mixed numerology slot structure 310, first sidelink signaling in accordance with the first SCS 330, as illustrated by and described with reference to FIG. 3. In some examples, aspects of the operations of 1810 may be performed by a first SCS component 1525 as described with reference to FIG. 15.

At 1815, the method may include transmitting, within a second set of one or more symbols of the slot associated with the mixed numerology sidelink slot structure, second sidelink signaling in accordance with a second SCS different from the first SCS. The operations of 1815 may be performed in accordance with examples as disclosed herein, such as the transmission by the UE 115-a, within the second set of one or more symbols 325 of the slot 315 associated with the mixed numerology slot structure 310, second sidelink signaling in accordance with the second SCS 335, as illustrated by and described with reference to FIG. 3. In some examples, aspects of the operations of 1815 may be performed by a second SCS component 1530 as described with reference to FIG. 15.

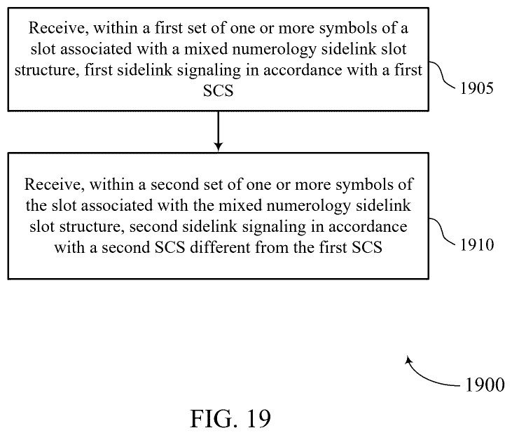

FIG. 19 shows a flowchart illustrating a method 1900 that supports mixed numerology slot structure for sidelink communication in accordance with one or more aspects of the present disclosure. The operations of the method 1900 may be implemented by a UE or its components as described herein. For example, the operations of the method 1900 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1905, the method may include receiving, within a first set of one or more symbols of a slot associated with a mixed numerology sidelink slot structure, first sidelink signaling in accordance with a first SCS. The operations of 1905 may be performed in accordance with examples as disclosed herein, such as the reception by the UE 115-b, within the first set of one or more symbols 320 of the slot 315 associated with the mixed numerology slot structure 310, first sidelink signaling in accordance with the first SCS 330, as illustrated by and described with reference to FIG. 3. The mixed numerology sidelink slot structure (equivalently referred to herein as a mixed numerology slot structure) may be the mixed numerology slot structure 400 of FIG. 4, the mixed numerology slot structure 500 of FIG. 5, the mixed numerology slot structure 600 of FIG. 6, the mixed numerology slot structure 700 of FIG. 7, the mixed numerology slot structure 800 of FIG. 8, the mixed numerology slot structure 900 of FIG. 9, or the mixed numerology slot structure 1000 of FIG. 10. In some examples, aspects of the operations of 1905 may be performed by a first SCS component 1525 as described with reference to FIG. 15.

At 1910, the method may include receiving, within a second set of one or more symbols of the slot associated with the mixed numerology sidelink slot structure, second sidelink signaling in accordance with a second SCS different from the first SCS. The operations of 1910 may be performed in accordance with examples as disclosed herein, such as the reception by the UE 115-b, within the second set of one or more symbols 325 of the slot 315 associated with the mixed numerology slot structure 310, second sidelink signaling in accordance with the second SCS 335, as illustrated by and described with reference to FIG. 3. In some examples, aspects of the operations of 1910 may be performed by a second SCS component 1530 as described with reference to FIG. 15.

The following provides an overview of aspects of the present disclosure:

Aspect 1: A method for wireless communication at a UE, comprising: communicating (e.g., transmitting or receiving), within a first set of one or more symbols of a slot associated with a mixed numerology sidelink slot structure, first sidelink signaling in accordance with a first SCS; and communicating (e.g., transmitting or receiving), within a second set of one or more symbols of the slot associated with the mixed numerology sidelink slot structure, second sidelink signaling in accordance with a second SCS different from the first SCS.

Aspect 2: The method of aspect 1, wherein the mixed numerology sidelink slot structure is associated with two or more SCSs comprising the first SCS and the second SCS; and the mixed numerology sidelink slot structure defines that one or more first symbols of the slot associated with AGC and one or more second symbols of the slot associated with a communication direction switch have a duration associated with a largest SCS of the two or more SCSs.

Aspect 3: The method of aspect 2, wherein remaining symbols of the slot outside of the one or more first symbols associated with the AGC and the one or more second symbols associated with the communication direction switch are associated with any combination of one or more of the two or more SCSs.

Aspect 4: The method of aspect 3, wherein the one or more first symbols associated with the AGC and the remaining symbols have a same power spectrum density.

Aspect 5: The method of any of aspects 1-4, wherein the UE generates a first symbol of the slot associated with AGC in accordance with a subsequent symbol of the slot that is adjacent to the first symbol.

Aspect 6: The method of aspect 5, wherein the first symbol is a duplication of the subsequent symbol in accordance with the first symbol and the subsequent symbol being associated with a same SCS.

Aspect 7: The method of any of aspects 5-6, wherein the subsequent symbol comprises a set of populated subcarriers, and the first symbol comprises a uniformly distributed subset of populated subcarriers from the set of populated subcarriers.

Aspect 8: The method of aspect 7, wherein the uniformly distributed subset of populated subcarriers within the first symbol is selected from the set of populated subcarriers within the subsequent symbol at a rate associated with a difference in SCS between the first symbol and the subsequent symbol.

Aspect 9: The method of any of aspects 1-8, wherein the mixed numerology sidelink slot structure defines that an initial symbol of the slot is associated with the first SCS; a last symbol of the slot is associated with a communication direction switch and has a duration associated with the first SCS; and a remainder of symbols of the slot is associated with the second SCS.

Aspect 10: The method of aspect 9, wherein the first SCS is equal to double the second SCS, and the slot comprises thirteen unique data symbols in accordance with the mixed numerology sidelink slot structure.

Aspect 11: The method of aspect 10, wherein an initial data symbol of the thirteen unique data symbols comprises a first set of populated subcarriers in a frequency domain, and the initial symbol of the slot comprises a duplication of a subset of the first set of populated subcarriers in the frequency domain.

Aspect 12: The method of any of aspects 9-11, wherein the slot comprises fifteen symbols in accordance with the mixed numerology sidelink slot structure.

Aspect 13: The method of any of aspects 1-8, wherein the mixed numerology sidelink slot structure defines that an initial symbol, a second symbol subsequent to the initial symbol, and a penultimate symbol of the slot are associated with the first SCS; a last symbol of the slot is associated with a communication direction switch and has a duration associated with the first SCS; and a remainder of symbols of the slot is associated with the second SCS.

Aspect 14: The method of aspect 13, wherein the first SCS is equal to double the second SCS, and the slot comprises fourteen unique data symbols in accordance with the mixed numerology sidelink slot structure.

Aspect 15: The method of aspect 14, wherein the initial symbol is a duplication of the second symbol, and the second symbol is an initial data symbol of the fourteen unique data symbols.

Aspect 16: The method of any of aspects 13-15, wherein the slot comprises sixteen symbols in accordance with the mixed numerology sidelink slot structure.

Aspect 17: The method of any of aspects 1-8, wherein the mixed numerology sidelink slot structure defines that an initial symbol, a second symbol subsequent to the initial symbol, and a penultimate symbol of the slot are associated with the first SCS; a last symbol of the slot is associated with a communication direction switch and has a duration associated with the first SCS; a third symbol subsequent to the second symbol and a symbol prior to the penultimate symbol of the slot are associated with the second SCS; and a remainder of symbols of the slot is associated with a third SCS different from the first SCS and the second SCS.

Aspect 18: The method of aspect 17, wherein the first SCS is equal to quadruple the third SCS, the second SCS is equal to double the third SCS, and the slot comprises sixteen unique data symbols in accordance with the mixed numerology sidelink slot structure.

Aspect 19: The method of aspect 18, wherein the initial symbol is a duplication of the second symbol, and the second symbol is an initial data symbol of the sixteen unique data symbols.

Aspect 20: The method of any of aspects 17-19, wherein the slot comprises seventeen symbols in accordance with the mixed numerology sidelink slot structure.

Aspect 21: The method of any of aspects 1-8, wherein the mixed numerology sidelink slot structure defines that an initial symbol and a symbol prior to a feedback symbol of the slot are associated with the first SCS; another symbol prior to the above latter symbol and a last symbol of the slot are associated with a communication direction switch and each have a duration associated with the first SCS; and a remainder of symbols of the slot is associated with the second SCS.

Aspect 22: The method of aspect 21, wherein the first SCS is equal to double the second SCS, and the slot comprises eleven unique data symbols and one feedback symbol in accordance with the mixed numerology sidelink slot structure.

Aspect 23: The method of any of aspects 21-22, wherein the slot comprises sixteen symbols in accordance with the mixed numerology sidelink slot structure.

Aspect 24: The method of any of aspects 1-8, wherein the mixed numerology sidelink slot structure defines that an initial symbol and a second symbol subsequent to the initial symbol of the slot are associated with the first SCS; a symbol prior to an initial feedback symbol and a last symbol of the slot are associated with a communication direction switch and each have a duration associated with the first SCS; and a remainder of symbols of the slot is associated with the second SCS.

Aspect 25: The method of aspect 24, wherein the first SCS is equal to double the second SCS, and the slot comprises eleven unique data symbols and two feedback symbols in accordance with the mixed numerology sidelink slot structure.

Aspect 26: The method of any of aspects 24-25, wherein the slot comprises sixteen symbols in accordance with the mixed numerology sidelink slot structure.

Aspect 27: The method of any of aspects 1-8, wherein the mixed numerology sidelink slot structure defines that an initial symbol, a second symbol subsequent to the initial symbol, a thirteenth symbol, and a fifteenth symbol prior to a feedback symbol of the slot are associated with the first SCS; a fourteenth symbol and a last symbol of the slot are associated with a communication direction switch and each have a duration associated with the first SCS; and a remainder of symbols of the slot is associated with the second SCS.

Aspect 28: The method of aspect 27, wherein the first SCS is equal to double the second SCS, and the slot comprises twelve unique data symbols and one feedback symbol in accordance with the mixed numerology sidelink slot structure.

Aspect 29: The method of any of aspects 27-28, wherein the slot comprises seventeen symbols in accordance with the mixed numerology sidelink slot structure.

Aspect 30: The method of any of aspects 1-8, wherein the mixed numerology sidelink slot structure defines that an initial symbol and a symbol prior to a feedback symbol of the slot are associated with the first SCS; another symbol prior to the above latter symbol and a last symbol of the slot are associated with a communication direction switch and each have a duration associated with the first SCS; and a remainder of symbols of the slot is associated with the second SCS.

Aspect 31: The method of aspect 30, wherein the first SCS is equal to quadruple the second SCS, and the slot comprises twelve unique data symbols and one feedback symbol in accordance with the mixed numerology sidelink slot structure.

Aspect 32: The method of any of aspects 30-31, wherein the slot comprises seventeen symbols in accordance with the mixed numerology sidelink slot structure.

Aspect 33: The method of any of aspects 1-32, wherein each symbol of the first set of one or more symbols comprises a first CP duration at a beginning of that symbol, the first CP duration associated with a first symbol size that corresponds to the first SCS and a fixed CP to symbol size ratio; and each symbol of the second set of one or more symbols comprises a second CP duration at a beginning of that symbol, the second CP duration associated with a second symbol size that corresponds to the second SCS and the fixed CP to symbol size ratio.

Aspect 34: The method of any of aspects 1-32, wherein the first set of one or more symbols comprises two symbols, an initial symbol of the two symbols excluding a CP and a second symbol of the two symbols comprising a CP duration at a beginning of the second symbol, the CP duration associated with a symbol size that corresponds to the second SCS; and each symbol of the second set of one or more symbols comprises the CP duration at a beginning of that symbol.

Aspect 35: The method of aspect 34, wherein the initial symbol of the two symbols is an AGC training symbol.

Aspect 36: The method of any of aspects 1-32, wherein the first set of one or more symbols comprises two symbols, an initial symbol of the two symbols comprising a CP duration at a beginning of the initial symbol and a second symbol of the two symbols excluding a CP, the CP duration associated with a symbol size that corresponds to the second SCS; and each symbol of the second set of one or more symbols comprises the CP duration at a beginning of that symbol.

Aspect 37: The method of aspect 36, wherein the second symbol of the two symbols is associated with a communication direction switch.

Aspect 38: The method of any of aspects 1-37, further comprising: receiving an indication of the mixed numerology sidelink slot structure, wherein communication (e.g., transmission or reception) in accordance with the mixed numerology sidelink slot structure is in association with reception of the indication of the mixed numerology sidelink slot structure.

Aspect 39: The method of aspect 38, further comprising: transmitting information indicative of a capability of the UE associated with one or more mixed numerology sidelink slot structures, wherein reception of the indication of the mixed numerology sidelink slot structure is in association with transmission of the information indicative of the capability of the UE.

Aspect 40: The method of any of aspects 38-39, wherein the UE receives the indication of the mixed numerology sidelink slot structure as an instruction to switch to the mixed numerology sidelink slot structure from another mixed numerology sidelink slot structure.

Aspect 41: The method of any of aspects 38-40, wherein the UE receives the indication of the mixed numerology sidelink slot structure as an instruction to switch to the mixed numerology sidelink slot structure from a uniform numerology sidelink slot structure.

Aspect 42: The method of any of aspects 1-41, further comprising: receiving an indication of a uniform numerology sidelink slot structure, wherein the UE receives the indication of the uniform numerology sidelink slot structure as an instruction to switch to the uniform numerology sidelink slot structure from the mixed numerology sidelink slot structure; and communicating (e.g., transmitting or receiving), within symbols of a second slot associated with the uniform numerology sidelink slot structure, third sidelink signaling in accordance with a uniform SCS.

Aspect 43: The method of any of aspects 1-42, wherein the UE selects or receives an indication of the mixed numerology sidelink slot structure in accordance with a satisfaction of one or more conditions.

Aspect 44: A UE for wireless communication, comprising one or more memories storing processor-executable code, and one or more processors coupled with the one or more memories and individually or collectively operable to execute the code to cause the UE to perform a method of any of aspects 1-43.

Aspect 45: A UE for wireless communication, comprising at least one means for performing a method of any of aspects 1-43.

Aspect 46: A non-transitory computer-readable medium storing code for wireless communication, the code comprising instructions executable by one or more processors to perform a method of any of aspects 1-43.

It should be noted that the methods described herein describe possible aspects. The operations and the steps may be rearranged or otherwise modified and other aspects are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and aspects are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, within a first set of one or more symbols of a slot associated with a mixed numerology sidelink slot structure, first sidelink signaling in accordance with a first subcarrier spacing; and
transmit, within a second set of one or more symbols of the slot associated with the mixed numerology sidelink slot structure, second sidelink signaling in accordance with a second subcarrier spacing different from the first subcarrier spacing.

2. The UE of claim 1, wherein the mixed numerology sidelink slot structure:
is associated with two or more subcarrier spacings comprising the first subcarrier spacing and the second subcarrier spacing; and
defines that one or more first symbols of the slot associated with automatic gain control and one or more second symbols of the slot associated with a communication direction switch have a duration associated with a largest subcarrier spacing of the two or more subcarrier spacings.

3. The UE of claim 2, wherein remaining symbols of the slot outside of the one or more first symbols associated with the automatic gain control and the one or more second symbols associated with the communication direction switch are associated with any combination of one or more of the two or more subcarrier spacings.

4. The UE of claim 3, wherein the one or more first symbols associated with the automatic gain control and the remaining symbols have a same power spectrum density.

5. The UE of claim 1, wherein the UE generates a first symbol of the slot associated with automatic gain control in accordance with a subsequent symbol of the slot that is adjacent to the first symbol.

6. The UE of claim 5, wherein the first symbol is a duplication of the subsequent symbol in accordance with the first symbol and the subsequent symbol being associated with a same subcarrier spacing.

7. The UE of claim 5, wherein:
the subsequent symbol comprises a set of populated subcarriers, and
the first symbol comprises a uniformly distributed subset of populated subcarriers from the set of populated subcarriers.

8. The UE of claim 7, wherein the uniformly distributed subset of populated subcarriers within the first symbol is selected from the set of populated subcarriers within the subsequent symbol at a rate associated with a difference in subcarrier spacing between the first symbol and the subsequent symbol.

9. The UE of claim 1, wherein:
each symbol of the first set of one or more symbols comprises a first cyclic prefix duration at a beginning of that symbol, the first cyclic prefix duration associated with a first symbol size that corresponds to the first subcarrier spacing and a fixed cyclic prefix to symbol size ratio; and
each symbol of the second set of one or more symbols comprises a second cyclic prefix duration at a beginning of that symbol, the second cyclic prefix duration associated with a second symbol size that corresponds to the second subcarrier spacing and the fixed cyclic prefix to symbol size ratio.

10. The UE of claim 1, wherein:
the first set of one or more symbols comprises two symbols, an initial symbol of the two symbols excluding a cyclic prefix and a second symbol of the two symbols comprising a cyclic prefix duration at a beginning of the second symbol, the cyclic prefix duration associated with a symbol size that corresponds to the second subcarrier spacing; and
each symbol of the second set of one or more symbols comprises the cyclic prefix duration at a beginning of that symbol.

11. The UE of claim 10, wherein the initial symbol of the two symbols is an automatic gain control training symbol.

12. The UE of claim 1, wherein:
the first set of one or more symbols comprises two symbols, an initial symbol of the two symbols comprising a cyclic prefix duration at a beginning of the initial symbol and a second symbol of the two symbols excluding a cyclic prefix, the cyclic prefix duration associated with a symbol size that corresponds to the second subcarrier spacing; and
each symbol of the second set of one or more symbols comprises the cyclic prefix duration at a beginning of that symbol.

13. The UE of claim 12, wherein the second symbol of the two symbols is associated with a communication direction switch.

14. The UE of claim 1, wherein the one or more processors are individually or collectively further operable to execute the code to cause the UE to:
receive an indication of the mixed numerology sidelink slot structure, wherein transmission in accordance with the mixed numerology sidelink slot structure is in association with reception of the indication of the mixed numerology sidelink slot structure.

15. The UE of claim 14, wherein the one or more processors are individually or collectively further operable to execute the code to cause the UE to:
transmit information indicative of a capability of the UE associated with one or more mixed numerology sidelink slot structures, wherein reception of the indication of the mixed numerology sidelink slot structure is in association with transmission of the information indicative of the capability of the UE.

16. The UE of claim 1, wherein the one or more processors are individually or collectively further operable to execute the code to cause the UE to:
receive an indication of a uniform numerology sidelink slot structure, wherein the UE receives the indication of the uniform numerology sidelink slot structure as an instruction to switch to the uniform numerology sidelink slot structure from the mixed numerology sidelink slot structure; and
transmit, within symbols of a second slot associated with the uniform numerology sidelink slot structure, third sidelink signaling in accordance with a uniform subcarrier spacing.

17. The UE of claim 1, wherein the UE selects or receives an indication of the mixed numerology sidelink slot structure in accordance with a satisfaction of one or more conditions.

18. A user equipment (UE), comprising:
one or more memories storing processor-executable code; and
one or more processors coupled with the one or more memories and individually or collectively operable to execute the code to cause the UE to:
receive, within a first set of one or more symbols of a slot associated with a mixed numerology sidelink slot structure, first sidelink signaling in accordance with a first subcarrier spacing; and
receive, within a second set of one or more symbols of the slot associated with the mixed numerology sidelink slot structure, second sidelink signaling in accordance with a second subcarrier spacing different from the first subcarrier spacing.

19. The UE of claim 18, wherein the mixed numerology sidelink slot structure:
is associated with two or more subcarrier spacings comprising the first subcarrier spacing and the second subcarrier spacing; and
defines that one or more first symbols of the slot associated with automatic gain control and one or more second symbols of the slot associated with a communication direction switch have a duration associated with a largest subcarrier spacing of the two or more subcarrier spacings.

20. The UE of claim 19, wherein remaining symbols of the slot outside of the one or more first symbols associated with the automatic gain control and the one or more second symbols associated with the communication direction switch are associated with any combination of one or more of the two or more subcarrier spacings.

21. The UE of claim 20, wherein the one or more first symbols associated with the automatic gain control and the remaining symbols have a same power spectrum density.

22. A method for wireless communication at a user equipment (UE), comprising:
transmitting, within a first set of one or more symbols of a slot associated with a mixed numerology sidelink slot structure, first sidelink signaling in accordance with a first subcarrier spacing; and
transmitting, within a second set of one or more symbols of the slot associated with the mixed numerology sidelink slot structure, second sidelink signaling in accordance with a second subcarrier spacing different from the first subcarrier spacing.

23. The method of claim 22, wherein the mixed numerology sidelink slot structure:
is associated with two or more subcarrier spacings comprising the first subcarrier spacing and the second subcarrier spacing; and
defines that one or more first symbols of the slot associated with automatic gain control and one or more second symbols of the slot associated with a communication direction switch have a duration associated with a largest subcarrier spacing of the two or more subcarrier spacings.

24. The method of claim 23, wherein remaining symbols of the slot outside of the one or more first symbols associated with the automatic gain control and the one or more second symbols associated with the communication direction switch are associated with any combination of one or more of the two or more subcarrier spacings.

25. The method of claim 24, wherein the one or more first symbols associated with the automatic gain control and the remaining symbols have a same power spectrum density.

26. The method of claim 22, wherein the UE generates a first symbol of the slot associated with automatic gain control in accordance with a subsequent symbol of the slot that is adjacent to the first symbol.

27. The method of claim 26, wherein the first symbol is a duplication of the subsequent symbol in accordance with the first symbol and the subsequent symbol being associated with a same subcarrier spacing.

28. The method of claim 26, wherein:
the subsequent symbol comprises a set of populated subcarriers, and
the first symbol comprises a uniformly distributed subset of populated subcarriers from the set of populated subcarriers.

29. The method of claim 28, wherein the uniformly distributed subset of populated subcarriers within the first symbol is selected from the set of populated subcarriers within the subsequent symbol at a rate associated with a difference in subcarrier spacing between the first symbol and the subsequent symbol.

30. A method for wireless communication at a user equipment (UE), comprising:
receiving, within a first set of one or more symbols of a slot associated with a mixed numerology sidelink slot structure, first sidelink signaling in accordance with a first subcarrier spacing; and
receiving, within a second set of one or more symbols of the slot associated with the mixed numerology sidelink slot structure, second sidelink signaling in accordance with a second subcarrier spacing different from the first subcarrier spacing.
